(19) United States
(12) Patent Application Publication
(10) Pub. No.: US 2022/0212796 A1
(43) Pub. Date: Jul. 7, 2022

(54) UNMANNED AERIAL VEHICLE

(71) Applicant: Bayer Aktiengesellschaft, Leverkusen (DE)

(72) Inventors: Malcolm FAERS, Düsseldorf (DE); Andrew Charles CHAPPLE, Lagenfeld (DE)

(73) Assignee: Bayer Aktiengesellschaft, Leverkusen (DE)

(21) Appl. No.: 17/595,087

(22) PCT Filed: May 6, 2020
(86) PCT No.: PCT/EP2020/062513

§ 371 Date: Nov. 8, 2021

(30) Foreign Application Priority Data
May 8, 2019 (EP) 19173404.5

(51) Int. Cl. B64D 1/18; A01M 7/00; B64C 39/02; B64D 47/08

(52) U.S. Cl. CPC B64D 1/18; A01M 7/0089; A01M 2200/01; B64D 47/08; B64C 2201/12; B64C 39/024

(57) ABSTRACT

The present invention relates to unmanned aerial vehicle for application of an active ingredient to agricultural crops. It is described to hold (310) a liquid comprising the active ingredient in a liquid reservoir housed within or attached to a body of the unmanned aerial vehicle. A liquid application unit is attached to the body of the unmanned aerial vehicle, and the liquid application unit is in fluid communication with the liquid reservoir. The liquid application unit receives (320) at least one input from a processing unit. The at least one input is useable to activate the liquid application unit. The unmanned aerial vehicle lands (330) within an environment to apply the liquid to at least one plant. The liquid application unit is activated (340) at a location determined by the processing unit based on image analysis of at least one image of the environment acquired by a camera.

### CROSS REFERENCE TO RELATED APPLICATIONS

This application is a national stage application under 35 U.S.C § 371 of International Application No. PCT/EP2020/062513, filed May 6, 2020, which claims the benefit of priority to European Application No. 19173404.5, filed May 8, 2019.

### FIELD OF THE INVENTION

The present invention relates to an unmanned aerial vehicle for application of an active ingredient to agricultural crops, to a system for application of an active ingredient to agricultural crops, and to a method for application of an active ingredient by an unmanned aerial vehicle to agricultural crops.

### BACKGROUND OF THE INVENTION

The general background of this invention is the application of active ingredients in liquid form to foliage, being applied by vehicles using for example boom sprayers. Active ingredients, such as herbicides, insecticides, fungicides, pesticides and nutritional supplements, are required to be applied in agricultural environments. Controlling weeds, insects and diseases in crops is an important requirement for reducing losses in agriculture. This is commonly achieved by foliar spray of crops by spray application from tractors, back-pack sprayers and unmanned aerial vehicles (UAV) such as drones and radio controlled helicopters. A disadvantage of all these application techniques is that typically, the whole field is sprayed. Furthermore, drift of the spray can occur resulting in unwanted off-target losses outside of the intended target spray area. There is a need to facilitate application in new ways, and to reduce the cost of such application. The general public increasingly also wishes to see a reduction in any environmental impact associated with such application.

### SUMMARY OF THE INVENTION

It would be advantageous to have improved means of applying active ingredients in agricultural environments.

The object of the present invention is solved with the subject matter of the independent claims, wherein further embodiments are incorporated in the dependent claims. It should be noted that the following described aspects and examples of the invention apply also for the unmanned aerial vehicle for application of an active ingredient to agricultural crops, to the system for application for application of an active ingredient to agricultural crops, and to the method for application of an active ingredient by an unmanned aerial vehicle to agricultural crops.

In some embodiments, an unmanned aerial vehicle for application of an active ingredient to agricultural crops may comprise:
a liquid reservoir. configured to hold a liquid comprising the active ingredient; and
at least one liquid application unit.

The at least one liquid application unit may be in fluid communication with the liquid reservoir. The at least one liquid application unit may be configured to receive at least one input from a processing unit. The at least one input may be used to activate the at least one liquid application unit. The unmanned aerial vehicle may be configured to land within an environment to apply the liquid to at least one plant. The at least one liquid application unit may be configured to be activated at a location determined by the processing unit based on image analysis of at least one image of the environment acquired by a camera.

In other words, an unmanned aerial vehicle (UAV), such as a drone, can land and apply an active ingredient, comprised within a liquid, to a plant. In some embodiments, the UAV can stop or feather the rotation of the rotor blades used for lift, which mitigates movement of foliage caused by downdraught from the rotor blades. Such movement of foliage can make it difficult to accurately and efficiently apply the active ingredient; by landing, the UAV may be able to apply the active ingredient accurately and efficiently to plants. The UAV can have a number of liquid reservoirs holding liquids with different active ingredients that can be applied via different liquid application units.

Furthermore, by landing and applying the liquid containing the active ingredient to plants, the effect of the downdraught of the rotor blades leading to drifting away of a liquid applied in spray form can be mitigated.

Additionally, by landing, the UAV is stationary when the liquid is applied, allowing the liquid to be applied more accurately to a plant as a result of being applied from a non-moving platform.

In some embodiments, imagery of an environment can be acquired by a drone or acquired by a different platform that could have previously acquired the imagery. The imagery may be transmitted to a processing unit which may be in the drone external to the drone. The processing unit may analyze the imagery to determine a location for activation of the liquid application unit carried by the drone. In this way, offline processing in a computer for example in a farmer's office of imagery acquired of a field can be used to determine in effect a map of locations where specific active ingredients within a liquid should be applied by a UAV (such as a drone) in that field.

In some embodiments, a drone can have a processing unit and be provided with imagery acquired by a different platform. The drone may then analyze the imagery to determine a location to activate its liquid application unit. It could do this before or after it lands. In some embodiments, while flying, the drone may determine a location for activation of its liquid application unit, fly to an appropriate site, land at said appropriate site, and then apply the liquid at the aforementioned location. In some embodiments, the drone may land at a site, analyze the imagery relating to an area in the vicinity of that site, and determine a location for application of the liquid.

In some embodiments, a drone may have a camera and may acquire imagery. The acquired imagery may be relayed to a processing unit that is external to the drone, for example a processing unit in a farmer's laptop by the side of the field. The processing unit may analyze the imagery using image processing to determine a location for activation of the liquid application unit. The image processing could occur before or after the drone lands. In some embodiments, the drone may be flying and may acquire imagery as it is flying. The acquired imagery may be relayed to a processing unit that may determine a location for activation of the drone's liquid application unit; this activation location may then be relayed back to the drone. The drone may then fly to an appropriate site, land, and then apply the liquid at the activation location. In some embodiments, the drone may land at a site and acquire imagery in the vicinity. That imagery may be relayed back and forth to an external processing unit that analyzes the imagery relating to the area in the vicinity of that site to determine a location for application of the liquid. The drone may then apply the liquid at that location.

In some embodiments, a drone may have a camera and may acquire imagery. In some embodiments, a drone may have a processing unit that analyses the imagery using image processing to determine a location for activation of the liquid application unit. The image processing could occur before or after the drone lands. In some embodiments, the drone may be flying and may acquire imagery as it is flying. This imagery may be analyzed by the drone's processing unit to determine a location for activation of its liquid application unit. The drone may then flies to an appropriate site, land, and then apply the liquid at the activation location. In some embodiments, the drone may land at a site and acquire imagery in the vicinity. That imagery may be analyzed by the processing unit to determine a location for application of the liquid. The drone may then apply the liquid at that location.

These methods may require less active ingredient because, instead of treating the entire crop, target weeds, insects, and disease can be treated directly. Also, because the liquid can be applied more efficiently to plants, less liquid is required, enabling a drone to treat a larger area with a smaller volume of liquid.

Liquid, for example for weed and/or pest control, carried by the unmanned aerial vehicle can be applied only where required and, based on analysis of acquired imagery, applied efficiently and effectively at those locations, rather than being applied indiscriminately. Thus, the unmanned aerial vehicle can treat a larger environment, because the liquid can be formulated for low volume applications and because only those areas of the environment that need to be treated are treated. This may reduce costs, as less liquid and active ingredient is used, and may reduce time spent treating, as smaller areas of the environment are treated more efficiently and effectively Furthermore, there are associated environmental benefits.

In some embodiments, the unmanned aerial vehicle comprises a camera, wherein the camera is configured to acquire the at least one image.

In some embodiments, the unmanned aerial vehicle comprises a processing unit. The processing unit is configured to carry out the analysis of the at least one image to determine the location for activation of the at least one liquid application unit.

In some embodiments, analysis of the at least one image to determine the at least one location for activation of the at least one liquid application unit comprises a determination of at least one type of weed. In some embodiments, analysis of the at least one image to determine the at least one location for activation of the at least one liquid application unit comprises a determination of at least one type of disease, and/or comprises a determination of at least one type of pest. In some embodiments, analysis of the at least one image to determine the at least one location for activation of the at least one liquid application unit comprises a determination of at least one type of insect. In some embodiments, analysis of the at least one image to determine the at least one location for activation of the at least one liquid application unit comprises a determination of at least one type of nutritional deficiency.

In some embodiments, the liquid application unit may be activated and the liquid may be applied in a manner which accounts for weeds to be controlled at a location and wherein the type of weed to be controlled can be taken into account. In some embodiments, the liquid may be applied in a manner which accounts for diseases to be controlled at a location and wherein the type of disease to be controlled can be taken into account. In some embodiments, the liquid may be applied in a manner which accounts for pests to be controlled at a location and wherein the type of pest to be controlled can be taken into account. In some embodiments, the liquid may be applied in a manner which accounts for insects to be controlled at a location and wherein the type of insect to be controlled can be taken into account. In some embodiments, the liquid may be applied in a manner which accounts for nutritional deficiencies to be mitigated at a location and wherein the type of nutritional deficiency to be mitigated can be taken into account.

In some embodiments, an unmanned aerial vehicle, such as a drone, may fly around an environment, such as a field, and, based on image processing of images acquired of the field, along with a determination of the presence of weeds, the type of weeds, and/or the location of weeds within said environment may apply a liquid containing the required active ingredient to control said weed and/or type of weed at the location of the weed. A drone can have a number of different reservoirs containing different liquids with different active ingredients; on the basis of the identified weed the appropriate liquid can be applied over the weed. In some embodiments, a number of different drones, each with a different liquid within its liquid reservoir containing different active ingredients, may fly around the field simultaneously can apply the liquid they carry where required.

In some embodiments, analysis of the at least one image to determine the at least one location for activation of the at least one liquid application unit comprises a determination of a site for the unmanned aerial vehicle to land.

The unmanned aerial vehicle may be flying and may be provided with a site to land or may determine a site to land itself. The site to land could be determined after a location for application of the liquid has already been made. Thus, a weed in a field can be identified and its location determined for example. An appropriate site for landing of the drone is then determined. Appropriate sites may include a site over the weed or a site adjacent to the weed, for example. The drone may then apply the liquid as required. In some embodiments, the site can be determined before a location for application of the liquid is determined. Thus, the drone can be provided with one or a number of landing sites within a field, or the drone can determine the landing site itself. The drone may land at these sites, acquire imagery at that location, and process the acquired imagery to determine locations in the vicinity for application of the liquid. In some embodiments, the drone may land at these sites and apply liquid in the vicinity based on imagery acquired by a different platform.

In some embodiments, the unmanned aerial vehicle is configured to land on at least one extendable leg that is attached to a body of the unmanned aerial vehicle.

In some embodiments, the unmanned aerial vehicle can land in areas that are not necessarily free from vegetation in order to apply a liquid containing an active ingredient to one or more plants. An UAV, such as a drone, may extend its legs to land, for example over a plant that will have liquid applied to it, or adjacent to or near to such a plant, and can do so in a safe and stable manner because the drone body and rotor blades are raised above a normal landing height. The leg(s) being extendable means that they are also retractable, enabling the legs to be retracted in normal flight providing for better fuel or battery power economy and stability in flight.

In some embodiments, an end of the at least one extendable leg that is distal to an end of the at least one extendable that is attached to the body of the unmanned aerial vehicle comprises at least one stability structure.

An UAV, such as a drone, can safely land in different ground areas, such as dry hard ground, or soft or marshy ground, and even in rice paddies.

In some embodiments, the at least one liquid application unit is moveable with respect to a body of the unmanned aerial vehicle. A processor of the unmanned aerial vehicle is configured to move the at least liquid application unit.

In this manner, the UAV can apply liquid in a very targeted manner to individual plants if required. This is because the UAV does not have to land in a precise position with respect to the plant, as would be required for a fixed liquid application unit, but can land in an appropriate position and then move the liquid application unit as required. This also means that in addition to applying the liquid in a targeted manner, the UAV can land more easily, because an appropriate landing site may be situated some distance from a plant to which liquid is to be applied. Also, the UAV if necessary can land at a site, before it is determined where the liquid is to be applied. Then the surrounding area can be imaged and image analysis may be used to determine locations for application of the liquid. Locations for application of the liquid may also be based on previously acquired imagery. The liquid application unit is then moved to the required location.

In some embodiments, the at least one liquid application unit is mounted on at least one extendable arm.

In some embodiments, when the unmanned aerial vehicle has landed within the environment the processor is configured to move the at least one liquid application unit to the location for activation of the at least one liquid application unit based on the image analysis of the at least one image of the environment.

In this way, image processing may be used not just for determining where to apply the liquid in the environment, but to enable the UAV to land in order to apply the liquid. Thus, a fully automated system that does not require any human input or control is provided.

In some embodiments, when the unmanned aerial vehicle comprises a camera, the camera can be configured to move with respect to the body of the unmanned aerial vehicle. A processor of the unmanned aerial vehicle may be configured to move the camera.

In this manner, as the UAV is flying around, the camera can be moved in order to image different parts of the environment without having to change an orientation of the UAV, as would be required if the camera was in a fixed position. Also, the UAV may be able to land at an appropriate site and then image the vegetation in its locality in order to determine locations for application of the liquid.

In some embodiments, the unmanned aerial vehicle is configured to determine the location for activation of the at least one liquid application unit after the unmanned aerial vehicle has landed within the environment.

In some embodiments, the unmanned aerial the vehicle comprises location determining means.

According to some embodiments, a system for application of an active ingredient to agricultural crops, may comprise:
i. at least one unmanned aerial vehicle according to the first aspect and any of the associated examples;
ii. at least one camera; and
iii. at least one processing unit, wherein, for an unmanned aerial vehicle of the at least one unmanned aerial vehicle:
   a processing unit of the at least one processing unit is configured to transmit the data useable to activate the at least one liquid application unit of the unmanned aerial unit;
   a camera of the at least one camera is configured to acquire the at least one image of the environment.

The camera may be configured to transmit the at least one image to the processing unit. The processing unit may be configured to analyze the at least one image to determine at least one location for activation of the at least one liquid application unit of the unmanned aerial vehicle that is in fluid communication with the liquid reservoir of the unmanned aerial vehicle.

According to some embodiments, a method for application of an active ingredient by an unmanned aerial vehicle to agricultural crops may comprise:

i. holding a liquid comprising the active ingredient in a liquid reservoir housed within or attached to a body of the unmanned aerial vehicle, wherein a liquid application unit is attached to the body of the unmanned aerial vehicle, and the liquid application unit is in fluid communication with the liquid reservoir;
ii. receiving by the liquid application unit at least one input from a processing unit, wherein the at least one input is useable to activate the liquid application unit;
iii. landing the unmanned aerial vehicle within an environment to apply the liquid to at least one plant; and
iv. activating the liquid application unit at a location determined by the processing unit based on image analysis of at least one image of the environment acquired by a camera.

Advantageously, the benefits provided by any of the above aspects equally apply to all of the other aspects and vice versa. The above aspects and examples will become apparent from and be elucidated with reference to the embodiments described hereinafter.

### BRIEF DESCRIPTION OF THE DRAWINGS

Exemplary embodiments will be described in the following with reference to the following drawings:

FIG. 1 shows a schematic set up of an unmanned aerial vehicle for application of an active ingredient to agricultural crops, according to some embodiments;

FIG. 2 shows a schematic set up of a system for application of an active ingredient to agricultural crops, according to some embodiments;

FIG. 3 shows a method for application of an active ingredient by an unmanned aerial vehicle to agricultural crops, according to some embodiments;

FIGS. 4a and 4b show a detailed example of the unmanned aerial vehicle of FIG. 1;

FIG. 5 shows spray deposits on rice, soybean and corn leaves, according to some embodiments; and

FIG. 6 shows spray coverage and spray deposit size on rice leaves at different spray volumes, according to some embodiments.

### DETAILED DESCRIPTION OF EMBODIMENTS

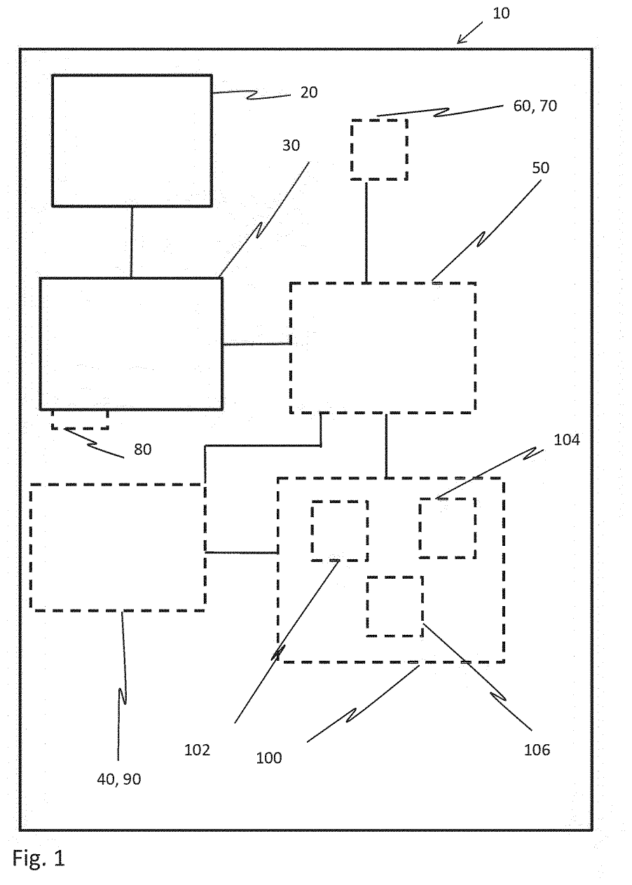

FIG. 1 shows an example of an unmanned aerial vehicle 10 for application of an active ingredient to agricultural crops, according to some embodiments. The unmanned aerial vehicle (UAV) 10 comprises a liquid reservoir 20. The liquid reservoir 20 is configured to hold a liquid comprising the active ingredient. The UAV 10 also comprises at least one liquid application unit 30. The at least one liquid application 30 unit is in fluid communication with the liquid reservoir 20. The at least one liquid application unit 30 may be configured to receive at least one input from a processing unit. The at least one input may be useable to activate the at least one liquid application unit 30. The unmanned aerial vehicle 10 may be configured to land within an environment to apply the liquid to at least one plant. The at least one liquid application unit 30 may be configured to be activated at a location determined by the processing unit based on image analysis of at least one image of the environment acquired by a camera.

In some embodiments, the liquid application unit comprises a spray gun or spray nozzle, configured to spray the liquid. Spraying of the liquid can comprise atomization of that liquid as part of the spray process.

In some embodiments, the liquid application unit comprises an application device configured to contact vegetation during application of the liquid. An example of such an application device is a paintbrush type device, which dispenses liquid to the brushes of the paintbrush which is applied to foliage in a brushing manner.

In some embodiments, the unmanned aerial vehicle comprises moveable vegetation holding means. When the unmanned aerial vehicle has landed within the environment the processor is configured to move the vegetation holding means to hold the at least one plant based on the image analysis of the at least one image of the environment. Thus a plant to which the liquid is being applied can be held steady during application. In an example, the moveable vegetation holding means comprises a moveable arm. In an example, the moveable arm is extendable.

In some embodiments, the unmanned aerial vehicle may be used for weed control along railway tracks and the surrounding area.

According to some embodiments, the unmanned aerial vehicle comprises a camera 40. The camera 40 may be configured to acquire the at least one image.

According to some embodiments, the unmanned aerial vehicle comprises a processing unit 50. The processing unit 50 is configured to carry out the analysis of the at least one image to determine the location for activation of the at least one liquid application unit.

In some embodiments, analysis of the at least one image to determine the at least one location for activation of the liquid application unit comprises a determination of at least one weed, and/or comprises a determination of at least one disease, and/or comprises a determination of at least one pest, and/or comprises a determination of at least one insect, and/or comprises a determination of at least one nutritional deficiency.

According to some embodiments, analysis of the at least one image to determine the at least one location for activation of the at least one liquid application unit comprises a determination of at least one type of weed, and/or comprises a determination of at least one type of disease, and/or comprises a determination of at least one type of pest, and/or comprises a determination of at least one type of insect, and/or comprises a determination of at least one type of nutritional deficiency.

In some embodiments, when a UAV such as a drone has a camera, if that drone images a weed that requires application with the liquid it carries, then it can immediately apply that liquid to that weed. However, if a determination is made that that weed should be controlled by a different liquid then this information and the location of the weed and the type of liquid to be applied at that location can be communicated to a different drone. This information could be communicated from the first drone or via a processing unit that is external to the first drone, to a second drone that carries the correct liquid. This second drone can then fly to the weed and applies the correct liquid over the weed. The unmanned aerial vehicle or vehicles operate in the same way with respect to controlling diseases, pests, insects and mitigating nutritional deficiencies.

In this way, the correct chemical is used in each location, increasing the effectiveness of application. There are associated environmental advantages because the most aggressive chemicals are used only where necessary.

In some embodiments, analysis of the at least one image comprises utilization of a machine learning algorithm.

In some embodiments, the machine learning algorithm comprises a decision tree algorithm.

In some embodiments, the machine learning algorithm comprises an artificial neural network.

In some embodiments, the machine learning algorithm may have been taught on the basis of a plurality of images. In some embodiments, the machine learning algorithm may have been taught on the basis of a plurality of images containing imagery of at least one type of weed, and/or at least of type of plant suffering from one or more diseases, and/or at least one type of plant suffering from insect infestation from one or more types of insect, and/or at least one type of insect (when the imagery has sufficient resolution), and/or at least one type of plant suffering from one or more pests, and/or at least one type of plant suffering from one or more types of nutritional deficiency. In some embodiments, the machine learning algorithm may have been taught on the basis of a plurality of images containing such imagery.

In some embodiments, a UAV 10 can have a one camera 40 and a processing unit 50 which uses the imagery acquired by the camera to activate the liquid application unit 30. The camera 40 may acquire imagery of the environment of a field. The imagery need not be acquired by the drone 10, but could be acquired by a different drone and then passed to the drone 10 for processing. The imagery acquired by the camera 40 may be at a resolution that enables vegetation to be identified as vegetation and indeed can be at resolution that enables one type of weed to be differentiated from another type of weed. The imagery can be at a resolution that enables pest or insect infested crops to be determined, either from the imagery of the crop itself or from acquisition of for examples insects themselves. The drone 10 can have a Global Positioning System (GPS) 102 and this enables the location of acquired imagery to be determined. For example the orientation of cameras 40 and the position of the drone 10 when imagery was acquired can be used to determine the geographical footprint of the image at the ground plane. The drone 10 can also have inertial navigation systems 104, based for example on laser gyroscopes. In addition to being used to determine the orientation of the drone 10 and hence of the camera 40, facilitating a determination of where on the ground the imagery has been acquired, the inertial navigation systems 104 can function alone without a GPS 102 to determine the position of the drone, by determining movement away from a known or a number of known locations, such as the filling/charging station. The camera 40 passes the acquired imagery to the processing unit 50. Image analysis software operates on the processing unit 50. The image analysis software can use feature extraction, such as edge detection, and object detection analysis that for example can identify structures such in and around the field such as buildings, roads, fences, hedges, etc. Thus, on the basis of known locations of such objects, the processing unit can patch the acquired imagery to in effect create a synthetic representation of the environment that can in effect be overlaid over a geographical map of the environment. Thus, the geographical location of each image can be determined, and there need not be associated GPS and/or inertial navigation based information associated with acquired imagery. In other words, an image based location system 106 can be used to locate the drone 10. However, if there is GPS and/or inertial navigation information available then the previously described image analysis that can place specific images at specific geographical locations based only on the imagery is not required. In some embodiments, if GPS and/or inertial navigation based information is available, then such image analysis can be used to augment the geographical location associated with an image.

In some embodiments, the processing unit 50 may run further image processing software. This software may analyze an image to determine the areas within the image where vegetation may be found. In some embodiments, the software may analyze the imagery to determine where vegetation may not be found (for example, at pathways across a field, around the borders of a field, and/or tractor wheel tracks across a field). This latter information can be used to determine where the liquid application is not required.

Vegetation can be detected based on the shape of features within acquired images. In some embodiments, edge detection software may be used to delineate the outer perimeter of objects and the outer perimeter of features within the outer perimeter of the object itself; organic material between ballast can be detected in a similar manner when the unmanned aerial vehicle is used for weed control along a railway track environment. A database of vegetation imagery can be used in helping determine if a feature in imagery relates to vegetation or not, using for example a trained machine learning algorithm such as an artificial neural network or decision tree analysis. In some embodiments, the camera may be configured to acquire multi-spectral imagery, with imagery having information relating to the color within images; this can be used alone or in combination with feature detection to determine where in an image vegetation is to be found. As discussed above, because the geographical location of an image can be determined, the location or locations of vegetation and/or other areas where the liquid is to be applied can be found in an image from knowledge of the size of an image on the ground, and can then be mapped to the exact position of that vegetation (area) on the ground.

In some embodiments, the processing unit 50 may run further image processing software that may determine vegetation location on the basis of feature extraction, if that is used. This software may comprise a machine learning analyzer. Images of specific weeds may be acquired. In some embodiments, information relating to the size of weeds may be used. Information relating to a geographical location in the world where such a weed is to be found and information relating to a time of year when that weed is to be found, including, for example, when such a weed is in flower, etc., can be tagged with the imagery. The names of the weeds can also be tagged with the imagery of the weeds. The machine learning analyzer, which can be based on an artificial neural network or a decision tree analyzer, may then be trained on this ground truth acquired imagery. In this way, when a new image of vegetation is presented to the machine learning analyzer, where such an image may have an associated time stamp such as time of year and a geographical location (e.g., Germany or South Africa) tagged to it, the machine learning analyzer determines the specific type of weed that is in the image through a comparison of imagery of a weed found in the new image with imagery of different weeds it has been trained on, where the size of weeds, the location the weeds can grow, and the times of year the weeds can grow can also be taken into account. The specific location of that weed type on the ground within the environment, and its size, can therefore be determined.

The processing unit 50 may have access to a database containing different weed types and the optimum liquid to be applied over that weed. This database may have been compiled from experimentally determined data. The image processing software, using the machine learning algorithm, may also have been taught to recognize insects, plants infested with insects, plants suffering from pests, and plants that are suffering from nutritional deficiencies. This may be done in the same manner as discussed above, through training based on previously acquired imagery. The database may also contain data indicating what liquid should be applied in what situation.

According to some embodiments, analysis of the at least one image to determine the at least one location for activation of the at least one liquid application unit comprises a determination of a site for the unmanned aerial vehicle to land.

According to some embodiments, the unmanned aerial vehicle may be configured to land on at least one extendable leg 60 that is attached to a body of the unmanned aerial vehicle.

In some embodiments, the at least one extendable leg comprises at least three legs.

In some embodiments, the unmanned aerial vehicle may be configured to land on the at least one extendable leg when the at least one extendable leg is in an extended configuration.

According to some embodiments, an end of the at least one extendable leg that is distal to an end of the at least one extendable that is attached to the body of the unmanned aerial vehicle comprises at least one stability structure 70.

In some embodiments, the at least one stability structure comprises one or more of: a spike; a disc; a ball; a cone; a mesh.

In some embodiments, the at least one extendible leg can extend to variable lengths to enable the unmanned aerial vehicle to land on uneven or sloping surfaces without falling over.

According to some embodiments, the at least one liquid application unit may be moveable with respect to a body of the unmanned aerial vehicle. A processor of the unmanned aerial vehicle may be configured to move the at least liquid application unit. The processor can be the processor 50 that analyses imagery if the UAV 10 includes the processor 50 and image analysis is not performed externally to the UAV.

According to some embodiments, the at least one liquid application unit may be mounted on at least one extendable arm 80.

According to some embodiments, when the unmanned aerial vehicle has landed within the environment, the processor may be configured to move the at least one liquid application unit to the location for activation of the at least one liquid application unit based on the image analysis of the at least one image of the environment.

In some embodiments, the processor of the unmanned aerial vehicle that is configured to move the liquid application unit may be the processing unit that is configured to analyze the image of the environment.

According to some embodiments, when the unmanned aerial vehicle comprises a camera, the camera can be configured to move with respect to the body of the unmanned aerial vehicle. A processor of the unmanned aerial vehicle may be configured to move the camera. The processor can be the processor 50 that analyses imagery if the UAV 10 includes the processor 50 and image analysis is not performed externally to the UAV.

In some embodiments, the camera may be mounted on an extendable arm 90.

In some embodiments, the extendable arm upon which the camera is mounted may be the same extendable arm upon which the liquid application unit is mounted.

In some embodiments, determination of the location for activation of the liquid application unit comprises movement of the camera.

In some embodiments, the processor of the unmanned aerial vehicle that is configured to move the camera may be the processing unit that is configured to analyse the image of the environment.

According to some embodiments, the unmanned aerial vehicle may be configured to determine the location for activation of the at least one liquid application unit after the unmanned aerial vehicle has landed within the environment.

According to some embodiments, the unmanned aerial the vehicle comprises location determining means 100.

In some embodiments, the location determining means may be configured to provide the processing unit with at least one location associated with the camera when the at least one image was acquired.

The location can be a geographical location with respect to a precise location on the ground, or can be a location on the ground that is referenced to another position or positions on the ground, such as a boundary of a field or the location of a drone docking station or charging station. In other words, an absolute geographical location can be utilized or a location on the ground that need not be known in absolute terms, but that is referenced to a known location can be used. Thus, by correlating an image with the location where it was acquired, the liquid application unit can be accurately activated at that location. Thus, even when, for example, a drone has run out of liquid and is flying back to a larger reservoir to fill up with liquid, the drone can continue to acquire imagery to be used to activate the liquid application unit at specific locations even if that location is not immediately addressed, i.e., the liquid may be applied later when the drone has re-charged and/or re-filled. Also, when the drone determines that a location should have a liquid applied that it is not carrying, that information can be logged and used by that drone later when it carries the required liquid or transmitted to another drone that carries that liquid, and that other drone can fly to the location and apply its liquid at that location.

In some embodiments, the location may be an absolute geographical location.

In some embodiments, the location may be a location that is determined with reference to a known location or locations. In other words, an image can be determined to be associated with a specific location on the ground, without knowing its precise geographical position, but by knowing the location where an image was acquired with respect to known position(s) on the ground the liquid application unit can then be activated at a later time at that location by moving the liquid application unit to that location or enabling another unmanned aerial vehicle to move to that location at activate its liquid application unit at that location.

In some embodiments, a GPS unit 102 may be used to determine, and/or may be used in determining, a location such as the location of the camera when specific images were acquired.

In some embodiments, an inertial navigation unit 104 may be used alone, or in combination with a GPS unit, to determine a location such as the location of the camera when specific images were acquired. In some embodiments, the inertial navigation unit comprising, for example, one or more laser gyroscopes, may be calibrated or zeroed at a known location (such as a drone docking or charging station) and, as the inertial navigation unit moves with the at least one camera, the movement away from that known location in x, y, and z coordinates can be determined, from which the location of the at least one camera at a time when images were acquired can be determined.

In some embodiments, image processing of acquired imagery 106 may be used alone, or in combination with a GPS unit, or in combination with a GPS unit and inertial navigation unit, to determine a location, such as the location of the camera when specific images were acquired. In other words, as the vehicle moves it can acquire imagery that is used to render a synthetic representation of the environment and from specific markers, such as the position of trees, field boundaries, roads, etc., the vehicle can determine its position within that synthetic environment from imagery it acquires.

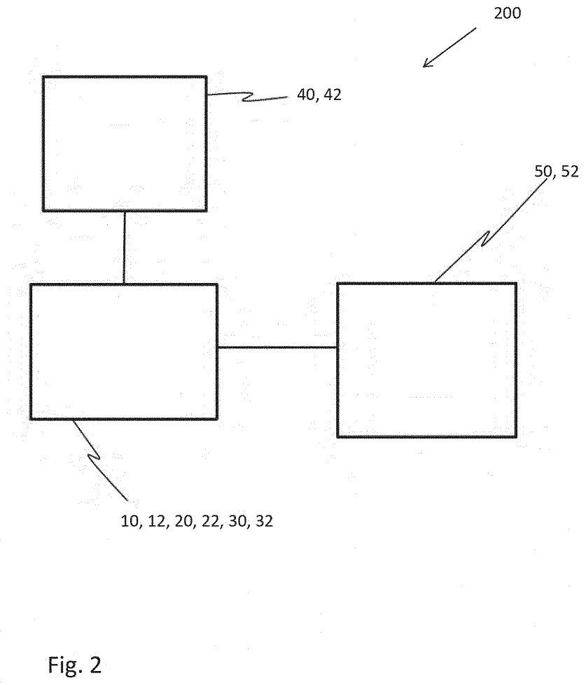

FIG. 2 shows a system 200 for application of an active ingredient to agricultural crops, according to some embodiments. The system 200 comprises at least one unmanned aerial vehicle 10 as described with respect to FIG. 1 and any of the associated examples. The system 200 also comprises at least one camera 40, and at least one processing unit 50. For an unmanned aerial vehicle 12 of the at least one unmanned aerial vehicle 10 the following may apply: a processing unit 52 of the at least one processing unit 50 may be configured to transmit the data useable to activate the at least one liquid application unit of the unmanned aerial unit; a camera 42 of the at least one camera 40 may be configured to acquire the at least one image of the environment. The camera 42 may be configured to transmit the at least one image to the processing unit 52. The processing unit 52 may be configured to analyze the at least one image to determine at least one location for activation of at least one liquid application unit 32 of the unmanned aerial vehicle 12 that is in fluid communication with a liquid reservoir 22 of the unmanned aerial vehicle 12.

In some embodiments, each unmanned aerial vehicle comprises a camera.

In some embodiments, each unmanned aerial vehicle comprises a processing unit.

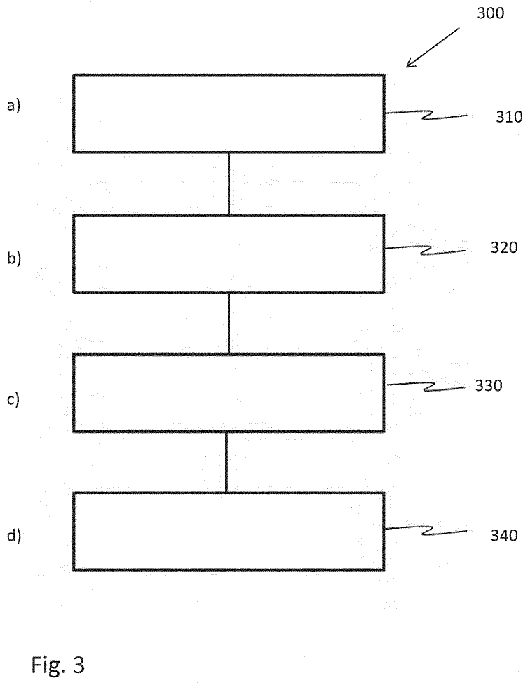

FIG. 3 shows a method 300 for application of an active ingredient by an unmanned aerial vehicle to agricultural crops in its basic steps, according to some embodiments. The method 300 comprises:
in a holding step 310, also referred to as step a), holding a liquid comprising the active ingredient in a liquid reservoir housed within or attached to a body of the unmanned aerial vehicle, wherein a liquid application unit is attached to the body of the unmanned aerial vehicle, and the liquid application unit is in fluid communication with the liquid reservoir;
in a receiving step 320, also referred to as step b), receiving by the liquid application unit at least one input from a processing unit, wherein the at least one input is useable to activate the liquid application unit;
in a landing step 330, also referred to as step c), landing the unmanned aerial vehicle within an environment to apply the liquid to at least one plant; and
in an activating step 340, also referred to as step d), activating the liquid application unit at a location determined by the processing unit based on image analysis of at least one image of the environment acquired by a camera.

In some embodiments, the unmanned aerial vehicle comprises a camera attached to the body of the unmanned aerial vehicle. The method can then comprise acquiring the at least one image by the camera of the unmanned aerial vehicle.

In some embodiments, the unmanned aerial vehicle comprises a processing unit housed within or attached to the body of the unmanned aerial vehicle. The method can then comprise analysing the at least one image to determine the location for activation of the liquid application unit by the processing unit of the unmanned aerial vehicle.

In some embodiments, in step d) analysing the at least one image to determine the at least one location for activation of the at least one liquid application unit comprises determining at least one type of weed, and/or comprises determining at least one type of disease, and/or comprises determining at least one type of pest, and/or comprises determining at least one type of insect, and/or comprises a determination of at least one type of nutritional deficiency.

In some embodiments, in step d) analysing the at least one image to determine the at least one location for activation of the at least one liquid application unit comprises determining a site for the unmanned aerial vehicle to land.

In some embodiments, step c) comprises landing on at least one extendable leg that is attached to the body of the unmanned aerial vehicle.

In some embodiments, an end of the at least one extendable leg that is distal to an end of the at least one extendable that is attached to the body of the unmanned aerial vehicles comprises at least one stability structure.

In some embodiments, the liquid application unit is moveable with respect to the body of the unmanned aerial vehicle, and wherein step d) comprises moving the liquid application unit under the control of the processing unit.

In some embodiments, the liquid application unit is mounted on an extendable arm.

In an exam in some embodiments ple, step d) comprises moving the liquid application unit to the location for activation of the liquid application unit based on the image analysis of the at least one image of the environment.

In some embodiments, when the camera is attached to the body of the unmanned aerial vehicle the method comprises moving the camera with respect to the body of the unmanned aerial vehicle, wherein a processor of the unmanned aerial vehicle is configured to move the camera.

In some embodiments, the method comprises determining the location for activation of the liquid application unit after the unmanned aerial vehicle has landed within the environment.

In some embodiments, the method comprises determining a location of the unmanned aerial vehicle using location determining means of the UAV.

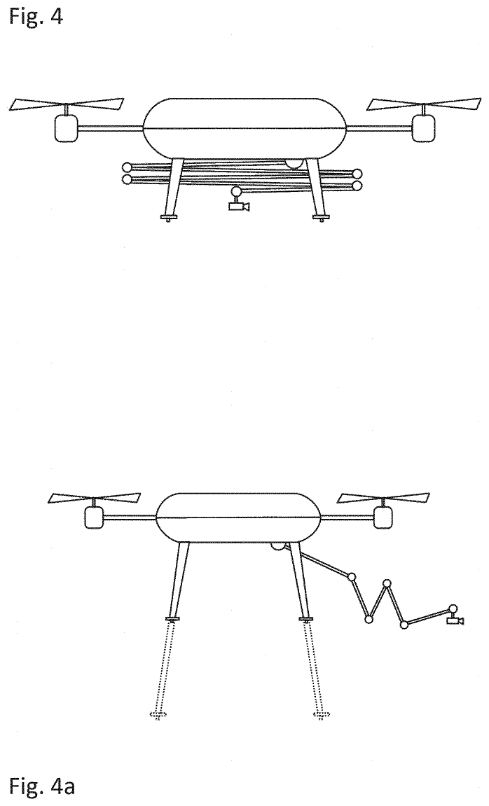

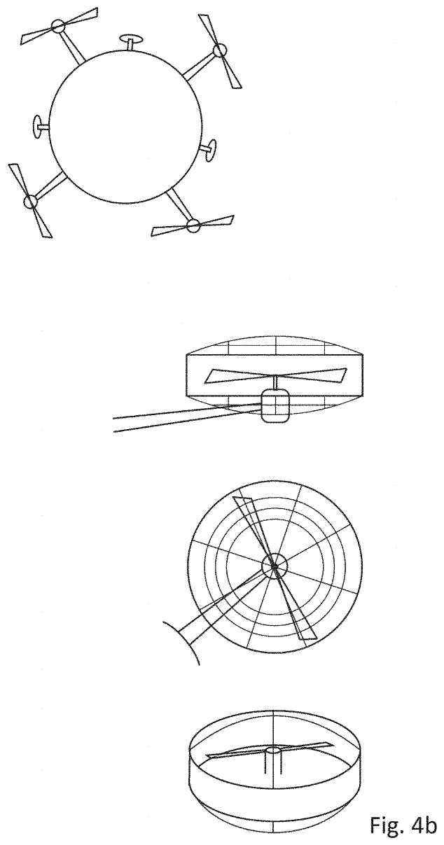

The unmanned aerial vehicle for application of an active ingredient to agricultural crops, system for application of an active ingredient to agricultural crops, and method for application of an active ingredient by an unmanned aerial vehicle to agricultural crops are now described in with respect to a very detailed embodiment as shown in FIG. 4.

In FIGS. 4a and 4b, a drone with three telescopic legs is shown, where one leg is hidden. The drone can have more than three legs. The drone has a moveable camera, allowing for image analysis identification of weeds, insects and diseases (hereafter, ‘target’) in the crop (either autonomously or if necessarily remotely by an operator). The drone also has an extendable arm which can apply a formulation of active ingredient(s) directly to the target via a liquid application unit. The drone can have more than one extendable arm. The liquid application unit need not be mounted on an extendable arm, and for example can be mounted under the drone body pointing directly downwards.

The drone of FIGS. 4a-b flies through a crop identifying targets or areas containing targets and then applies formulations of active ingredients (hereafter, ‘formulation’) directly to the weeds, insects and diseases. Normally this can be problematic while the drone is flying since the downdraught from the rotors causes both extensive and rapid movement of the crop foliage which prevents accurate application. Also, normally the movement of the drone in-flight, dealing for example with the effects upon the drone of side winds, means that the swath cannot be considered a straight line (c.f., a tractor mounted boom sprayer). The drone of FIGS. 4a-b however uses the three telescopic legs to briefly land, and stop or feather the rotation of the rotors, identify the application target, and apply the formulation via the extendable arm. Once the target has been treated the drone then flies to the next plant and repeats this process until the required crop area has been treated. Thus, the drone can treat every plant in a crop, but can also determine which plants need to be treated either in flight, or when on the ground.

In this way significantly less active ingredient(s) is required since the target weeds, insects and disease are treated directly rather than the whole crop. Furthermore, products can be applied directly and do not first need to be diluted in larger volumes of water for spray application. This has the additional advantage that the weight of product for application that the drone carries can be substantially reduced allowing for the use of much smaller, cheaper and more efficient drones with extended operating times between recharging or exchange of the batteries. Similarly, this application method allows the formulator to exploit the advantages of more concentrated active ingredients and surfactants in smaller deposits.

Thus, purposely designed formulations with appropriate physical stability can be utilized, providing appropriate wetting for the crop, appropriate biodelivery for the active ingredients, and appropriate resistance to wash-off by rain.

Off-target losses by drift can be greatly reduced or even effectively eliminated, allowing application to occur in populated and environmentally sensitive areas. Furthermore, the drone can continue to operate in conditions where the wind is too strong for application methods that generate even low levels of spray drift.

The drone can operate autonomously, reducing the labor required to control targets in agricultural crops.

As shown in FIGS. 4a-b the drone has four sets of rotors. In some embodiments, the drone may have fewer or more than this, or may have just one set of rotors. The rotors may be protected from contact with crop foliage by a protective ring surrounding the rotors and a protective mesh above and below the rotors. The ends of the telescopic legs have a disc and spike, enabling stable landing. However, the ends of the telescopic legs can contain a spike, disc, ball, cone or mesh shaped end to aid stable placement on the ground (for rice paddies and other areas, etc.). The area occupied by the telescopic legs on the ground may be such that the center of gravity of the drone assembly including the extendable arm falls always within the footprint area of the telescopic legs. The moveable camera(s) can be monoscopic or stereoscopic and can view images both in the visible and/or infrared and/or near UV spectrum to aid identification of targets. A UV, visible, and/or IR wavelength light can also be included to enhance imaging of targets. The camera can either be mounted directly on the drone with a movable mounting or mounted at the end of one or more extendable arms. If necessary the camera can be mounted to the drone body in a non-moveable way.

The images from the camera can be analysed by suitable image analysis software to identify targets. This can be performed autonomously onboard the drone with a dedicated processing unit or it can be performed remotely by a separate processing unit with/without input from the operator.

The extendable arm(s) can extend over a range of distances. At the end of the arm there is a liquid application unit which can squirt, spray or paint the formulated active ingredient onto the target. The extendable arm can also carry a camera. Additional extendable arms can also be included to temporarily hold the target steady during application, to position it correctly for application or to temporarily hold aside foliage which covers the target.

The formulations are preferably liquid including gels and can be aqueous or oil based and include SC, SE, OD, CS, EC, EW, ME and SL types by example. The formulations are preferably applied directly without dilution although it is also possible to first dilute the formulations in water or other suitable liquids prior to application. The formulations can be contained in purposely designed bottles (liquid reservoirs) that can be directly attached to the extendable arm(s) (d) thus providing an enclosed system with minimal contact of the formulations with the operator. Furthermore, the purposely designed bottles can also include the liquid application unit. Furthermore, the drone can carry a range of formulations containing different active ingredients for controlling different weeds, insects and diseases in purposely designed bottles and these can be selected as required by the extendable arm(s).

The following relates to specific detailed examples of agrochemical compositions used for the sprayable liquid:

an aqueous dispersion comprising
a) at least one agrochemical active compound, which is solid at room temperature,
b) at least one compound of the group selected from mono- and diesters of sulfosuccinate metal salts with branched or linear alcohols comprising 1-10 carbon atoms, in particular alkali metal salts, more particular sodium salts, and most particular sodium dioctylsulfosuccinate;
c) at least one polyalkyleneoxide modified heptamethyltrisiloxane,
d) at least one emulsion polymer or polymer dispersion with Tg in the range from −100° C. to 30° C.,
e) one or more additives selected from the group consisting of non-ionic or anionic surfactants or dispersing aids,
f) at least one rheological modifier,
g) at least one antifoam agent,
h) optionally other formulants, and
i) at least one compatibilizer.

In some embodiments, the compounds a) to i) may be present in an amount of
i. 10 to 600 g/l, preferably 50 to 400 g/l, more preferably 100 to 400 g/l, most preferred 200 to 360 g/l
ii. 1 to 80 g/l, preferably 4 to 60 g/l, more preferably 4 to 50 g/l, most preferred 10 to 30 g/l
iii. 1 to 70 g/l, preferably 2.5 to 50 g/l, more preferably 5 to 45 g/l, most preferred 10 to 40 g/l
iv. 1 to 80 g/l, preferably 2.5 to 60 g/l, more preferably 5 to 55 g/l, most preferred 10 to 50 g/l
v. 1 to 100 g/l, preferably 2.5 to 80 g/l, more preferably 5 to 60 g/l, most preferred 20 to 45 g/l
vi. 0.5 to 60 g/l, preferably 1 to 40 g/l, more preferably 1 to 20 g/l, most preferred 1 to 15 g/l
vii. 1 to 25 g/l, preferably 1 to 20 g/l, more preferably 1 to 15 g/l, most preferred 1 to 10 g/l
viii. 0 to 150 g/l, preferably 1 to 100 g/l, more preferably 5 to 60 g/l, most preferred 20 to 45 g/l
ix. 1 to 70 g/l, preferably 2.5 to 50 g/l, more preferably 5 to 45 g/l, most preferred 10 to 40 g/l
   wherein water is added to volume (1 litre).

In some embodiments, the formulation may be used without dilution (e.g. direct application by UAVs) and the compounds a) to i) may be present in an amount of
i. 0.5 to 500 g/l, preferably 1 to 400 g/l, more preferably 5 to 200 g/l, most preferred 10 to 100 g/l
ii. 0.2 to 60 g/l, preferably 0.4 to 40 g/l, more preferably 0.6 to 25 g/l, most preferred 1 to 20 g/l
iii. 0.2 to 70 g/l, preferably 0.4 to 50 g/l, more preferably 0.6 to 35 g/l, most preferred 1 to 20 g/l
iv. 0.2 to 60 g/l, preferably 0.4 to 50 g/l, more preferably 0.6 to 40 g/l, most preferred 1 to 20 g/l
v. 0.01 to 100 g/l, preferably 0.05 to 80 g/l, more preferably 0.1 to 60 g/l, most preferred 1 to 45 g/l
vi. 0.1 to 60 g/l, preferably 0.5 to 30 g/l, more preferably 0.7 to 20 g/l, most preferred 1 to 15 g/l
vii. 0.001 to 25 g/l, preferably 0.01 to 20 g/l, more preferably 0.1 to 15 g/l, most preferred 0.2 to 10 g/l
viii. 0 to 180 g/l, preferably 1 to 150 g/l, more preferably 1 to 140 g/l, most preferred 2 to 120 g/l
ix. 0.2 to 70 g/l, preferably 0.4 to 50 g/l, more preferably 0.6 to 35 g/l, most preferred 1 to 20 g/l
   wherein water is added to volume (1 litre).

Some embodiments may be directed to agrochemical compositions as described above with components b) and d) as optional components.

Therefore, an aqueous dispersion containing the following components is also may comprise:
i. at least one agrochemical active compound, which is solid at room temperature,
ii. optionally mono- and diesters of sulfosuccinate metal salts with branched or linear alcohols comprising 1-10 carbon atoms, in particular alkali metal salts, more particular sodium salts, and most particular sodium dioctylsulfosuccinate;
iii. at least one polyalkyleneoxide modified heptamethyltrisiloxane,
iv. optionally an emulsion polymer or polymer dispersion with Tg in the range from −100° C. to 30° C.,
v. one or more additives selected from the group consisting of non-ionic or anionic surfactants or dispersing aids,
vi. at least one rheological modifiers
vii. at least one antifoam agent,
viii. optionally other formulants,
ix. at least one polyalkylene oxide block copolymer, preferably a polyalkylene oxide block copolymer (i) which has a molecular weight (weight-average molecular weight M_{w}) of 1,500 to 6,000 g/mol and an ethylene oxide content of 8 to 45%, preferably a molecular weight of 1,800 to 5,000 g/mol and an ethylene oxide content of 10 to 35%, more preferably a molecular weight of 2,000 to 4,000 g/mol and an ethylene oxide content of 15 to 30% and especially preferred a molecular weight of 2,200 to 3,000 g/mol and an ethylene oxide content of 18 to 22%.

If not otherwise indicated, % in this application means percent by weight.

Moreover, it was found that a sprayable liquid for low volume application, as described above, was solved by compositions, comprising adjuvant combinations comprising at least one of each compounds b), c) and i).

Therefore, in some embodiments, a sprayable liquid is an adjuvant combination for agrochemical compositions with low spray volumes.

In said adjuvant combination preferably compound
b) is sodium dioctylsulfosuccinate,
c) is polyalkyleneoxide modified heptamethyltrisiloxane,
i) is a polyalkylene oxide block copolymer (i).

In some embodiments, the compounds b, c and i are present in a ratio from 1:1:1 to 1:4:3, preferably from 1:1:1 to 1:3:3, and most preferred in a ratio from 1:1.5:1.5 to 1:2.5:2.5.

In some embodiments, the compounds c and i are present in a ratio from 4:1 to 1:4, preferably from 2:1 to 1:2, and most preferred in a ratio from 4:3 to 3:5.

In some embodiments, the amount of said surfactants b, c and i in the agrochemical compositions may be from 10 to 200 g/l, preferable from 15 to 150 g/l, more preferred from 20 to 120 g/l, and most preferred from 40 to 100 g/l, wherein preferably ratios given above apply.

Furthermore, it was found that a sprayable liquid for low volume application, as described above, was solved by compositions, comprising alternative adjuvant combinations comprising at least one of each compounds b), c) and d).

Therefore, in some embodiments, a sprayable liquid is an adjuvant combination for agrochemical compositions with low spray volumes.

In said adjuvant combination preferably compound
b) is sodium dioctylsulfosuccinate,
c) is polyalkyleneoxide modified heptamethyltrisiloxane,
d) at least one emulsion polymer or polymer dispersion with Tg in the range from −100° C. to 30° C.

In some embodiments, the compounds b, c and d are present in a ratio from 1:1:1 to 1:6:3, preferably from 1:1:1 to 1:5:3, and most preferred in a ratio from 1:1.5:1.5 to 1:3:3.

In some embodiments, the compounds c and d are present in a ratio from 4:1 to 1:4, preferably from 3:1 to 1:3, and most preferred in a ratio from 2:1 to 1:2.

In some embodiments, the amount of said surfactants b, c and d in the agrochemical compositions may be from 10 to 200 g/l, preferable from 15 to 160 g/l, more preferred from 20 to 140 g/l, and most preferred from 40 to 130 g/l, wherein preferably ratios given above apply.

A Suitable compounds a) of the compositions are agrochemical active compounds which are solid at room temperature.

Solid, agrochemical active compounds a) are to be understood in the present composition as meaning all substances customary for plant treatment, whose melting point is above 20° C. Fungicides, bactericides, insecticides, acaricides, nematicides, molluscicides, herbicides, plant growth regulators, plant nutrients, biological actives substances and repellents may preferably be mentioned.

The active compounds identified here by their common names are known and are described, for example, in the pesticide handbook (“The Pesticide Manual” 16th Ed., British Crop Protection Council 2012) or can be found on the Internet (e.g. http://www.alanwood.net/pesticides). The classification is based on the current IRAC Mode of Action Classification Scheme at the time of filing of this patent application.

In an example, the insecticide is one or more of: abamectin; acetamiprid; acrinathrin; acynonapyr; benzpyrimoxan; broflanilide; clothianidin; cyantraniliprole; chlorantraniliprole; cyclaniliprole; dicloromezotiaz; dodecadienol; flubendiamide; fluhexafon; imidacloprid; nitenpyram, chlorfenapyr; emamectin; ethiprole; fipronil; flonicamid; flupyradifurone; indoxacarb; metaflumizone; methoxyfenozid; milbemycin; oxazosulfyl; pyridaben; pyridalyl; silafluofen; spinosad; spirodiclofen; spiromesifen; spirotetramat; sulfoxaflor; tetraniliprole; thiacloprid; thiamethoxam; triflumezopyrim; triflumuron; and other insecticides can be used.

In an example, the fungicide is one or more of: amisulbrom; bixafen; fenamidone; fenhexamid; fluopicolide; fluopyram; fluoxastrobin; iprovalicarb; isotianil; pencycuron; penflufen; propineb; prothioconazole; tebuconazole; trifloxystrobin; ametoctradin; amisulbrom; azoxystrobin; benthiavalicarb-isopropyl; benzovindiflupyr; boscalid; carbendazim; chlorothanonil; cyazofamid; cyflufenamid; cymoxanil; cyproconazole; dichlobentiazox; difenoconazole; dipymetitrone; ethaboxam; epoxiconazole; famoxadone; fenpicoxamid; florylpicoxamid; fluazinam; fluopimomide; fludioxonil; fluindapyr; fluquinconazole; flusilazole; flutianil; fluxapyroxad; ipfentrifluconazole; ipflufenoquin; isopyrazam; kresoxim-methyl; lyserphenvalpyr; mancozeb; mandipropamid; mefentrifluconazole; oxathiapiprolin; penthiopyrad; picarbutrazox; picoxystrobin; probenazole; proquinazid; pydiflumetofen; pyraclostrobin; pyraziflumid; pyridachlometyl; quinofumelin; sedaxane; tebufloquin; tetraconazole; valiphenalate; zoxamide; N-cyclopropyl-3-(difluoromethyl)-5-fluoro-N-(2-isopropylbenzyl)-1-methyl-1H-pyrazole-4-carboxamide; 2-{3-[2-(1-{[3,5-bis(difluoromethyl)-1H-pyrazol-1-yl]acetyl}-piperidin-4-yl)-1,3-thiazol-4-yl]-4,5-dihydro-1,2-oxazol-5-yl}-3-chlorophenyl methanesulfonat; and other fungicides can be used.

In an example, the herbicide comprises all applicable forms such as acids, salts, ester, with at least one applicable form): aclonifen; amidosulfuron; bensulfuron-methyl; bromoxynil; bromoxynil potassium; chlorsulfuron; clodinafop; clodinafop-propargyl; clopyralid; cyclopyranil; 2,4-D, 2,4-D-dimethylammonium, -diolamin, -isopropylammonium, -potassium, -triisopropanolammonium, and -trolamine; 2,4-DB, 2,4-DB dimethylammonium, -potassium, and -sodium; desmedipham; dicamba; diflufenican; diuron; ethofumesate; ethoxysulfuron; fenoxaprop-P; fenquinotrione; flazasulfuron; florasulam; florpyrauxifen; florpyrauxifen-benzyl; flufenacet; fluroxypyr; flurtamone; fomesafen; fomesafen-sodium; foramsulfuron; glufosinate; glufosinate-ammonium; glyphosate; glyphosate-isopropylammonium, -potassium, and trimesium; halauxifen; halauxifen-methyl; halosulfuron-methyl; indaziflam; iodosulfuron-methyl-sodium; isoproturon; isoxaflutole; lenacil; MCPA; MCPA-isopropylammonium, -potassium, and sodium; MCPB; MCPB-sodium; mesosulfuron-methyl; mesotrione; metosulam; metribuzin; metsulfuron-methyl; napropamide; napropamide-M; nicosulfuron; pendimethalin; penoxsulam; phenmedipham; picolinafen; pinoxaden; propoxycarbazone-sodium; pyrasulfotole; pyroxasulfone; pyroxsulam; rimsulfuron; saflufenacil; sulcotrion; tefuryltrione; tembotrione; thiencarbazone-methyl; tolpyralate; topramezone; triafamone; tribenuron-methyl; trifludimoxazin; and other herbicides can be used.

Preferred safeners a) or h) are: Mefenpyr-diethyl, Cyprosulfamide, Isoxadifen-ethyl, (RS)-1-methylhexyl (5-chloroquinolin-8-yloxy)acetate (Cloquintocet-mexyl, CAS-No.: 99607-70-2), metcamifen.

Suitable active ingredients may optionally additionally include soluble active ingredients for example dissolved in the aqueous carrier phase and/or liquid active ingredient(s) for example dispersed as an emulsion in the aqueous carrier phase.

All named active ingredients as described here above can be present in the form of the free compound and/or, if their functional groups enable this, an agriculturally acceptable salt thereof. Furthermore, mesomeric forms as well as stereoisomeres or enantiomeres, where applicable, shall be enclosed, as these modifications are well known to the skilled artisan, as well as polymorphic modifications.

B Suitable alkylsulfosuccinates b) are mono- and diesters of sulfosuccinate metal salts with branched or linear alcohols comprising 1-10 carbon atoms, in particular alkali metal salts, more particular sodium salts, and most particular sodium dioctylsulfosuccinate;

C Suitable organosilicone ethoxylates c) are organomodified polysiloxanes/trisiloxane alkoxylates with the following CAS No. 27306-78-1, 67674-67-3, 134180-76-0, e.g., Silwet® L77, Silwet® 408, Silwet® 806, BreakThru® 5240, BreakThru® 5278.

D Suitable acrylic based emulsion polymers or polymer dispersions and styrene based emulsion polymers or polymer dispersions d) are aqueous polymer dispersions with a Tg in the range from −100° C. to 30° C., preferably between −60° C. and 20° C., more preferably between −50° C. and 10° C., most preferably between −45° C. and 5° C., for example Acronal V215, Acronal 3612, Licomer ADH 205 and Atplus FA. Particularly preferred are Licomer ADH205, and Atplus FA.

Preferably, the polymer is selected from the group consisting of acrylic polymers, styrene polymers, vinyl polymers and derivatives thereof, polyolefins, polyurethanes and natural polymers and derivatives thereof.

In some embodiment, the polymer, as described above, has a molecular weight of no more than 40000, preferably no more than 10000.

In some embodiments the polymer D is an emulsion polymer as described in WO 2017/202684.

The glass transition temperature (Tg) is known for many polymers and is determined, if not defined otherwise, according to ASTM E1356-08 (2014) “Standard Test Method for Assignment of the Glass Transition Temperatures by Differential Scanning calorimetry” wherein the sample is dried prior to DSC at 110° C. for one hour to eliminate effect of water and/or solvent, DSC sample size of 10-15 mg, measured from −100° C. to 100° C. at 20° C./min under N2, with Tg defined as midpoint of the transition region.

E Suitable non-ionic surfactants or dispersing aids e) are all substances of this type which can customarily be employed in agrochemical agents. Preferably, polyethylene oxide-polypropylene oxide block copolymers, polyethylene glycol ethers of branched or linear alcohols, reaction products of fatty acids or fatty acid alcohols with ethylene oxide and/or propylene oxide, furthermore polyvinyl alcohol, polyoxyalkylenamine derivatives, polyvinylpyrrolidone, copolymers of polyvinyl alcohol and polyvinylpyrrolidone, and copolymers of (meth)acrylic acid and (meth)acrylic acid esters, furthermore branched or linear alkyl ethoxylates and alkylaryl ethoxylates, where polyethylene oxide-sorbitan fatty acid esters may be mentioned by way of example. Out of the examples mentioned above selected classes can be optionally phosphated, sulphonated or sulphated and neutralized with bases.

Possible anionic surfactants e) are all substances of this type which can customarily be employed in agrochemical agents. Alkali metal, alkaline earth metal and ammonium salts of alkylsulphonic or alkylphospohric acids as well as alkylarylsulphonic or alkylarylphosphoric acids are preferred. A further preferred group of anionic surfactants or dispersing aids are alkali metal, alkaline earth metal and ammonium salts of polystyrenesulphonic acids, salts of polyvinylsulphonic acids, salts of alkylnaphthalene sulphonic acids, salts of naphthalenesulphonic acid-formaldehyde condensation products, salts of condensation products of naphthalenesulphonic acid, phenolsulphonic acid and formaldehyde, and salts of lignosulphonic acid.

F A rheological modifier is an additive that when added to the recipe at a concentration that reduces the gravitational separation of the dispersed active ingredient during storage results in a substantial increase in the viscosity at low shear rates. Low shear rates are defined as 0.1 s−1 and below and a substantial increase as greater than ×2. The viscosity can be measured by a rotational shear rheometer.

Suitable rheological modifiers f) by way of example are:
i. Polysaccharides including xanthan gum, guar gum and hydroxyethyl cellulose. Examples are Kelzan®, Rhodopol® G and 23, Satiaxane® CX911 and Natrosol® 250 range.
ii. Clays including montmorillonite, bentonite, sepeolite, attapulgite, laponite, hectorite. Examples are Veegum® R, Van Gel® B, Benton® CT, HC, EW, Pangel® M100, M200, M300, S, M, W, Attagel® 50, Laponite® RD,
iii. Fumed and precipitated silica, examples are Aerosil® 200, Siponat® 22.
   Preferred are xanthan gum, montmorillonite clays, bentonite clays and fumed silica.

G Suitable antifoam substances g) are all substances which can customarily be employed in agrochemical agents for this purpose. Silicone oils, silicone oil preparations are preferred. Examples are Silcolapse® 426 and 432 from Bluestar Silicones, Silfoam® SRE and SC132 from Wacker, SAF-184® fron Silchem, Foam-Clear ArraPro-S® from Basildon Chemical Company Ltd, SAG 1572 and SAG 30 from Momentive [Dimethyl siloxanes and silicones, CAS No. 63148-62-9]. Preferred is SAG 1572.

H Suitable other formulants h) are selected from biocides, antifreeze, colourants, pH adjusters, buffers, stabilisers, antioxidants, inert filling materials, humectants, crystal growth inhibitors, micronutrients by way of example are:
Possible preservatives are all substances which can customarily be employed in agrochemical agents for this purpose. Suitable examples for preservatives are preparations containing 5-chloro-2-methyl-4-isothiazolin-3-one [CAS-No. 26172-55-4], 2-methyl-4-isothiazolin-3-one [CAS-No. 2682-20-4] or 1.2-benzisothiazol-3(2H)-one [CAS-No. 2634-33-5]. Examples which may be mentioned are Preventol® D7 (Lanxess), Kathon® CG/ICP (Dow), Acticide® SPX (Thor GmbH) and Proxel® GXL (Arch Chemicals).

Suitable antifreeze substances are all substances which can customarily be employed in agrochemical agents for this purpose. Suitable examples are propylene glycol, ethylene glycol, urea and glycerine.

Possible colourants are all substances which can customarily be employed in agrochemical agents for this purpose. Titanium dioxide, carbon black, zinc oxide, blue pigments, Brilliant Blue FCF, red pigments and Permanent Red FGR may be mentioned by way of example.

Possible pH adjusters and buffers are all substances which can customarily be employed in agrochemical agents for this purpose. Citric acid, sulfuric acid, hydrochloric acid, sodium hydroxide, sodium hydrogen phosphate (Na2HPO4), sodium dihydrogen phosphate (NaH2PO4), potassium dihydrogen phosphate (KH2PO4), potassium hydrogen phosphate (K2HPO4), may be mentioned by way of example.

Suitable stabilisers and antioxidants are all substances which can customarily be employed in agrochemical agents for this purpose. Butylhydroxytoluene [3.5-Di-tert-butyl-4-hydroxytoluol, CAS-No. 128-37-0] is preferred.

I Compatibilizing agent selected from the group consisting of
i. a polyalkylene oxide block copolymer (i), preferably a polyalkylene oxide block copolymer which has a molecular weight (weight-average molecular weight M_{w}) of 1,500 to 6,000 g/mol and an ethylene oxide content of 8 to 45%, more preferably a molecular weight of 1,800 to 5,000 g/mol and an ethylene oxide content of 10 to 35%, even more preferably a molecular weight of 2,000 to 4,000 g/mol and an ethylene oxide content of 15 to 30% and especially preferred a molecular weight of 2,200 to 3,000 g/mol and an ethylene oxide content of 18 to 22%;
ii. block-copolymer of polyethylene oxide and polypropylene oxide other than defined above;
iii. ethoxylated branched alcohols (e.g. Genapol® X-type) with 2-20 E0 units;
iv. methyl end-capped, ethoxylated branched alcohols (e.g. Genapol® XM-type) comprising 2-20 E0 units;
v. ethoxylated coconut alcohols (e.g. Genapol® C-types) comprising 2-20 E0 units;
vi. ethoxylated C12/15 alcohols (e.g. Synperonic® A-types) comprising 2-20 E0 units;
vii. propoxy-ethoxylated alcohols, branched or linear, e.g. Antarox® B/848, Atlas® G5000, Lucramul® HOT 5902;
viii. ethoxylated diacetylene-diols (e.g. Surfynol® 4xx-range);
ix. propoxy-ethoxylated fatty acids, Me end-capped, e.g. Leofat® OC0503M;
x. alkyl ether citrate surfactants (e.g. Adsee CE range, Akzo Nobel);
xi. alkylpolysaccharides (e.g. Agnique® PG8107, PG8105, Atplus® 438, AL-2559, AL-2575);
xii. ethoxylated mono- or diesters of glycerine comprising fatty acids with 8-18 carbon atoms and an average of 10-40 EO units (e.g. Crovol® range);
xiii. castor oil ethoxylates comprising an average of 5-40 EO units (e.g. Berol® range, Emulsogen® EL range).

In a most preferred embodiment the compatibilizer is polyalkylene oxide block copolymer i), more preferred with a molecular weight of 2,400 to 2,500 g/mol and an ethylene oxide content of 20%.

If not otherwise defined in this application, the molecular weight refers to the weight-average molecular weight Mw which is determined by GPC in methylene chloride at 25° C. with polystyrene as the standard.

The formulations were prepared according to the following methods.

### Method 1:

The method of the preparation of suspension concentrate formulations are known in the art and can be produced by known methods familiar to those skilled in the art. A 2% gel of the xanthan (f) in water and the biocides (h) was prepared with low shear stirring. The active ingredient(s) (a), non-ionic and anionic dispersants (e), a portion of the antifoam (g) and other formulants (h) were mixed to form a slurry, first mixed with a high shear rotor-stator mixer (Ultra-Turrax®) to reduce the particle size D(v,0.9) to approximately 50 microns, then passed through one or more bead mills (Eiger® 250 Mini Motormill) to achieve a particles size D(v,0.9) typically 1 to 15 microns as required for the biological performance of the active ingredient(s). Those skilled in the art will appreciate that this can vary for different active ingredients. The remaining components: mono- and diesters of sulfosuccinate metal salts (b), polyalkyleneoxide modified heptamethyltrisiloxane (c), emulsion polymer or polymer dispersion (d), portion of the antifoam (g) and xanthan gel prepared above were added and mixed in with low shear stirring until homogeneous. Finally the pH was adjusted to 7.0 (+/−0.2) with acid or base (h).

### Materials:

### List of Materials, CAS-Numbers Etc

TABLE I
Exemplified trade names and CAS-No's of preferred compounds b)

| | Tradename | Company | General description | CAS- No. |
|---|---|---|---|---|
| 1 | Aerosol ® OT | Cytec | dioctylsulfosuccinate | 577-11-7 |
| | 70PG | | sodium salt (70%) | |
| 2 | Geropon ® | Solvay | dioctylsulfosuccinate | 577-11-7 |
| | DOS-PG | | sodium salt (65-70%) | |
| 3 | Synergen ® | Clariant | dioctylsulfosuccinate | 577-11-7 |
| | W10 | | sodium salt (65-70%) | |
| 4 | Lankropol ® | Akzo- | dioctylsulfosuccinate | 577-11-7 |
| | KPH70 | Nobel | sodium salt (70%) | |

TABLE II
Exemplified trade names and CAS-No's of preferred compounds c)

| | | | Molecular | |
|---|---|---|---|---|
| Product | Chemical name | Cas No. | formula | Supplier |
| Silwet ® | 3-(2-methoxyethoxy)propyl-methyl- | 27306- | C13H34O4Si3 | Momentive |
| L77 | bis(trimethylsilyloxy)silane | 78-1 | | |
| Silwet ® | 2-[3- | 67674- | C14H38O5Si4 | Momentive |
| 408 | [[dimethyl(trimethylsilyloxy)silyl]oxy- | 67-3 | | |
| | methyl- | | | |
| | trimethylsilyloxysilyl]propoxy]ethanol | | | |
| Silwet ® | 3-[methyl- | 134180- | C15H38O5Si3 | Momentive |
| 806 | bis(trimethylsilyloxy)silyl]propan-1- | 76-0 | | |
| | ol; 2-methyloxirane;oxirane | | | |
| Break- | 3-[methyl- | 134180- | C15H38O5Si3 | Evonik |
| thru ® | bis(trimethylsilyloxy)silyl]propan-1- | 76-0 | | |
| S240 | ol; 2-methyloxirane;oxirane | | | |
| Break- | 3-(2-methoxyethoxy)propyl-methyl- | 27306- | C13H34O4Si3 | Evonik |
| thru ® | bis(trimethylsilyloxy)silane | 78-1 | | |
| S278 | | | | |

TABLE III
Exemplified trade names and CAS-No's of preferred compounds d)

| | Tradename | Company | General description | Tg |
|---|---|---|---|---|
| 1 | Atplus ® FA | Croda | Aqueous styrene acryl- | <30° C. |
| | | | ic co-polymer emul- | |
| | | | sion dispersion | |
| 2 | Acronal ® V215 | BASF | aqueous acrylate co- | −43° C. |
| 3 | Acronal ® V115 | | polymer dispersion | −58° C. |
| 4 | Acronal ® A245 | | containing carboxylic | −45° C. |
| 5 | Acronal ® A240 | | groups. | −30° C. |
| 6 | Acronal ® A225 | | | −45° C. |
| 7 | Acronal ® A145 | | | −45° C. |
| 8 | Acronal ® 500 D | BASF | aqueous acrylic co- | −13° C. |
| 9 | Acronal ® S 201 | | polymer dispersion | −25° C. |
| 10 | Acronal ® DS 3618 | BASF | aqueous acrylic ester | −40° C. |
| 11 | Acronal ® 3612 | | co-polymer dispersion | +12° C. |
| 12 | Acronal ® V 212 | | | −40° C. |
| 13 | Acronal ® DS 3502 | | | +4° C. |
| 14 | Acronal ® S 400 | | | −8° C. |
| 15 | Licomer ® | Michel- | aqueous acrylic ester | <30° C. |
| | ADH205 | man | | |
| 16 | Licomer ® | | co-polymer dispersion | |
| | ADH203 | | containing carboxylic | |
| | | | groups. | |
| 17 | Primal ® CM-160 | DOW | Aqueous acrylic | |
| 18 | Primal ® CM-330 | | emulsion polymer | |

TABLE IV
Exemplified trade names and CAS-No's of preferred compounds e)

| | Tradename | Company | General description | CAS- No. |
|---|---|---|---|---|
| 1 | Synperonic ® | Croda | block-copolymer of | 9003-11-6 |
| | PE/F127 | | polyethylene oxide | |
| | | | and polypropylene | |
| | | | oxide | |
| 2 | Pluronic ® P105 | BASF | block-copolymer of | 9003-11-6 |
| | | | polyethylene oxide | |
| | | | and polypropylene | |
| | | | oxide | |
| 3 | Soprophor ® | Solvay | tristyrylphenol | 119432-41- |
| | 4D384 | | ethoxylate (16EO) | 6 |
| | | | sulfate ammonium | |
| | | | salt | |
| 4 | Morwet ® D425 | Akzo | Naphthalene | 9008-63-3 |
| | | Nobel | sulphonate | |
| | | | formaldehyde | |
| | | | condensate Na salt | |
| 5 | Atlox ® 4913 | Croda | methyl methacrylate | 119724-54- |
| | | | graft copolymer with | 8 |
| | | | polyethylene glycol | |

TABLE V
Exemplified trade names and CAS-No's of preferred compounds f)

| Tradename | Company | General description | CAS- No. |
|---|---|---|---|
| Xanthan | | Polysaccharide | 11138-66-2 |
| Aerosil ® | Evonik | Hydrophilic fumed silica | 112945-52-5 |
| 200 | | | 7631-86-9 |
| Aerosil ® | Evonik | Hydrophilic fumed silica | 112945-52-5 |
| R972 | | | 7631-86-9 |
| Aerosil ® | Evonik | Hydrophilic fumed silica | 112945-52-5 |
| R974 | | | 7631-86-9 |
| Aerosil ® | Evonik | Hydrophilic fumed silica | 112945-52-5 |
| XXX grades | | | 7631-86-9 |
| Attagel ® | BASF | Attapulgite clay, Palygorskite | 12174-11-7 |
| 50 | | ([Mg(Al 0.5-1 Fe 0-0.5 )]Si 4 | |
| | | (OH)O 10 × 4 H 2 O | |
| Laponite ® | Laporte | Laponite, Silicic acid, lithium | 53320-86-8 |
| RDS/RD | | magnesium sodium salt | |
| Veegum ® | Vanberbilt | Montmorillonite, smectite | 12199-37-0 |
| R | | clay | |
| Van Gel ® | Vanberbilt | Montmorillonite | 12199-37-0 |
| B | | | |
| Bentone ® | Elementis | Bentonite | |
| CT | | | |
| Bentone ® | Elementis | Bentonite | |
| HC | | | |
| Bentone ® | Elementis | Hectorite | 12173-47-6 |
| EW | | ((Mg2.67Li0.33)Si4Na0.33[F0. | |
| | | 5-1(OH)0-0.5]2O10) | |
| Pangel ® | Tolsa | Sepeolite or Bentonite | |
| M100, | | | |
| M200, | | | |
| M300 | | | |
| Pangel ® | Tolsa | Sepeolite or Bentonite | |
| S, M, W | | | |
| Sipernat ® | Evonik | Hydrophilic fumed silica | 112945-52-5 |
| 22 | | | 7631-86-9 |

TABLE VI
Exemplified trade names and CAS-No's of preferred compounds g)

| | Tradename | Company | General description | CAS- No. |
|---|---|---|---|---|
| 1 | Silcolapse ® | Blue Star | Dimethyl siloxanes | 63148-62-9 |
| | 411 | Silicones | and silicones | |
| 2 | Silcolapse ® | Blue Star | Dimethyl siloxanes | 63148-62-9 |
| | 426 | Silicones | and silicones | |
| 3 | Silcolapse ® | Blue Star | Dimethyl siloxanes | 63148-62-9 |
| | 432 | Silicones | and silicones | |
| 4 | SAG ® 1572 | Momentive | Dimethyl siloxanes | 63148-62-9 |
| | | | and silicones | |
| 5 | SAG ® 30 | Momentive | Dimethyl siloxanes | 63148-62-9 |
| | | | and silicones | |
| 6 | Silfoam ® | Wacker | Dimethyl siloxanes | 63148-62-9 |
| | SRE | | and silicones | |
| 7 | Foam-Clear | Basildon | Dimethyl siloxanes | 63148-62-9 |
| | ArraPro-S ® | Chemical | and silicones | |
| | | Company | | |
| | | Ltd | | |
| 8 | SAF-184 ® | Silchem | Dimethyl siloxanes | 63148-62-9 |
| | | | and silicones | |

TABLE VII
Exemplified trade names and CAS-No's of preferred compounds h)

| Tradename | Company | General description | CAS- No. |
|---|---|---|---|
| Proxel ® GXL | Arch | 1.2-benzisothiazol-3(2H)- | 2634-33-5 |
| | Chemicals | one | |
| Kathon ® | Dow | 5-chloro-2-methyl-4- | 26172-55-4 |
| CG/ICP | | isothiazolin-3-one plus 2- | plus |
| | | methyl-4-isothiazolin-3-one | 2682-20-4 |
| Glycerine | | propane-1,2,3-triol | 56-81-5 |
| Butylhydroxy- | | 3.5-Di-tert-butyl-4- | 128-37-0 |
| toluene | | hydroxytoluol | |
| Acticide ® SPX | Thor | 5-chloro-2-methyl-4- | 26172-55-4, |
| | | isothiazolin-3-one plus 2- | 2682-20-4, |
| | | methyl-4-isothiazolin-3-one | 55965-84-9 |
| Acticide ® BIT | Thor | 1.2-benzisothiazol-3(2H)- | 2634-33-5 |
| 20 N | | one | |
| Propylene glycol | | 1,2-Propylene glycol | 57-55-6 |
| Preventol ® D7 | Lanxess | | |
| CF | AG | | |
| Preventol ® BIT | Lanxess | 1.2-benzisothiazol-3(2H)- | 2634-33-5 |
| 20 N | AG | one | |
| sodium hydrogen | | Na₂HPO₄ | |
| phosphate | | | |
| sodium dihydro- | | NaH₂PO₄ | |
| gen phosphate | | | |
| potassium | | KH₂PO₄ | |
| dihydrogen | | | |
| phosphate | | | |
| potassium hydro- | | K₂HPO₄ | |
| gen phosphate | | | |

TABLE VIII
Exemplified trade names and CAS-No's of preferred compounds i)

| Tradename | Company | General description | CAS- No. |
|---|---|---|---|
| Synperonic ® PE/L62 | Croda | block-copolymer of | 9003-11-6 |
| | | polyethylene oxide and | |
| | | polypropylene oxide | |
| Pluronic ® PE/L62 | BASF | block-copolymer of | 9003-11-6 |
| | | polyethylene oxide and | |
| | | polypropylene oxide | |
| Ultraric ® PE 62 | Oxiteno | block-copolymer of | 9003-11-6 |
| | | polyethylene oxide and | |
| | | polypropylene oxide | |
| Synperonic ® PE/L61 | Croda | block-copolymer of | 9003-11-6 |
| | | polyethylene oxide and | |
| | | polypropylene oxide | |
| Synperonic ® PE/L64 | Croda | block-copolymer of | 9003-11-6 |
| | | polyethylene oxide and | |
| | | polypropylene oxide | |
| Synperonic ® PE/L44 | Croda | block-copolymer of | 9003-11-6 |
| | | polyethylene oxide and | |
| | | polypropylene oxide | |
| Synperonic ® | Croda | block-copolymer of | 9003-11-6 |
| PE/L121 | | polyethylene oxide and | |
| | | polypropylene oxide | |
| Synperonic ® | Croda | block-copolymer of | 9003-11-6 |
| PE/L103 | | polyethylene oxide and | |
| | | polypropylene oxide | |
| Synperonic ® PE/L84 | Croda | block-copolymer of | 9003-11-6 |
| | | polyethylene oxide and | |
| | | polypropylene oxide | |

### Example 1

Formulations were prepared with the following recipes:

TABLE IX
Composition of recipes 1, 2 and 3.

| | Recipe 1 | Recipe 2 | |
|---|---|---|---|
| | For the described | For the described | |
| | sprayable liquid | sprayable liquid | |
| | for low volume | for low volume | Recipe 3 |
| Component (g/l) | spray application | spray application | reference |
| Penflufen (a) | 90 | 90 | 90 |
| Tebuconazole (a) | 180 | 180 | 180 |
| Non-ionic dispersants | 20 | 20 | 20 |
| (e1) | | | |
| Anionic dispersants | 20 | 20 | 20 |
| (e3) | | | |
| Aerosol ® OT 70PG | 10 | 10 | 0 |
| (b) | | | |
| Silwet ® 408 (c) | 50 | 30 | 0 |
| Synperonic ® PE L62 | 50 | 30 | 0 |
| (i) | | | |
| Xanthan (f) | 1.6 | 1.6 | 2.8 |
| Proxel ® GXL (h) | 1.8 | 1.8 | 1.8 |
| Kathon ® CG/ICP (h) | 0.8 | 0.8 | 0.8 |
| Glycerine (h) | 100 | 100 | 100 |
| Licomer ® ADH205 | 20 | 20 | 0 |
| (d) | | | |
| SAG ® 1572 (g) | 4 | 6 | 2.5 |
| Na₂HPO₄/NaH₂PO₄ | 1.5/0.8 | 1.5/0.8 | 0 |
| (Buffer solution pH = | | | |
| 7) | | | |
| Water (add to 1 litre) | To volume | To volume | To volume |
| | (~540) | (~578) | (~662) |

The method of preparation used was according to Method 1.

### Example 2

In another example 1 litre each of recipes 2 and 3 were diluted in 7 litres of water and sprayed by a Maruyama MMC940AC drone fitted with two Yamaha flat fan nozzles flying at a height of 2 m at an application rate of 8 l/ha onto leaf sections taken from rice, soybean and corn plants. A fluorescent marker (Tinopal OB®) was added and the spray coverage determined from analysis of images obtained under UV illumination. The drone flew at a height of 2 m and a speed of 15-20 km/h.

TABLE X
Leaf coverage after spray application by drone at 8 l/ha.

| Leaf coverage % | rice | soybean | corn |
|---|---|---|---|
| Recipe 2 (For the described | 48.9 | 46.1 | 30.6 |
| sprayable liquid for low volume | | | |
| spray application) | | | |
| Recipe 3 (reference) | 2.34 | 4.08 | 6.73 |

The results shown in table X demonstrate that recipe 2 (For the described sprayable liquid for low volume spray application) showed a much improved wetting and coverage of each of the leaf surfaces.

### Example 3

In another example recipes 2 and 3 were diluted at a rate of 1 litre of SC in 7 litres of water and sprayed by a Maruyama MMC940AC drone fitted with two Yamaha flat fan nozzles flying at a height of 2 m at an application rate of 8 l/ha onto rice plants (cv. Koshihikari) in pots at the growth stage of full tillering with the same application conditions as above. The rice plants were inoculated with Rhizoctonia solani 17 days after application followed by incubation at 25° C. and 100% relative humidity for 7 days under dark conditions. The rice plants were then grown in a greenhouse for 18 days and assessed for disease control.

TABLE XI
disease control after spray application by drone at 8 l/ha.

| | Height | | |
|---|---|---|---|
| | of lesions | Average | % |
| Biological Results | (mm) | (mm) | Efficacy |
| Control | 140, 100, 130 | 123.3 | |
| Recipe 2 (For the described | 0, 50, 35 | 28.3 | 77.0 |
| sprayable liquid for low | | | |
| volume spray application) | | | |
| Recipe 3 (reference) | 80, 75, 75 | 76.7 | 37.8 |

The results in table XI demonstrate that recipe 2 (For the described sprayable liquid for low volume spray application) gave enhanced control of disease.

In another example recipes 2 and 3 were diluted at a rate of 1 litre of SC in a range of water volumes ranging from 1200 l/ha to 4 l/ha and along with a small amount of a fluorescent label and were sprayed by a back-pack sprayer onto outdoor rice plants (japonica) fitted with (Teejet) Conejet® TXVS nozzles (1200-600 l/ha TXVS-8, 300-4 l/ha TXVS-2) at the growth stage of ripening. The spray deposits on isolated rice leaves were photographed under UV illumination and the coverage of the spray and mean spray deposit area was measured using ImageJ image analysis software (Fiji package, www.fiji.com).

TABLE XII
Leaf coverage and spray deposit area at different spray volumes.

| | % coverage on | | Mean spray | |
|---|---|---|---|---|
| | rice leaves - | | deposit area mm² - | |
| | recipe 2 (For | | recipe 2 (For | |
| | the described | % coverage on | the described | Mean spray |
| Spray | sprayable liquid | rice leaves - | sprayable liquid | deposit area mm² - |
| volume | for low volume | recipe 3 | for low volume | recipe 3 |
| l/ha | spray application) | (reference) | spray application) | (reference) |
| 1200 | 44.7 | 23.5 | 0.72 | 0.26 |
| 600 | 41.9 | 35.5 | 1.00 | 0.41 |
| 300 | 39.3 | 20.4 | 0.29 | 0.11 |
| 200 | 27.3 | 14.0 | 0.16 | 0.10 |
| 100 | 13.3 | 10.6 | 0.12 | 0.087 |
| 50 | 35.6 | 9.2 | 0.64 | 0.077 |
| 20 | 26.8 | 8.4 | 0.41 | 0.13 |
| 8 | 39.4 | 5.2 | 1.12 | 0.089 |
| 4 | 25.8 | 3.7 | 1.04 | 0.11 |

The results in table XII demonstrate that recipe 2 (for the described sprayable liquid for low volume spray application) remarkably gave significantly improved coverage at 50 to 4 l/ha compared to the reference recipe 3. At 100 l/ha the coverage was significantly lower for recipe 2 demonstrating the importance of low spray volumes less than or equal to 50 l/ha for achieving a significantly higher leaf coverage of the spray mixture. At 200 to 1200 l/ha a higher coverage was observed from the greater spray volume. Importantly, recipe 2 sprayed at 4 to 50 l/ha achieved a comparable coverage to the reference recipe 3 at 600 l/ha demonstrating that the described sprayable liquid for low volume spray application can achieve comparable coverage to reference formulations sprayed at much higher conventional spray volumes. However, the reference formulation 3 did not achieve comparable coverage at low spray volumes less than 100 l/ha with the coverage decreasing as the spray volume decreased.

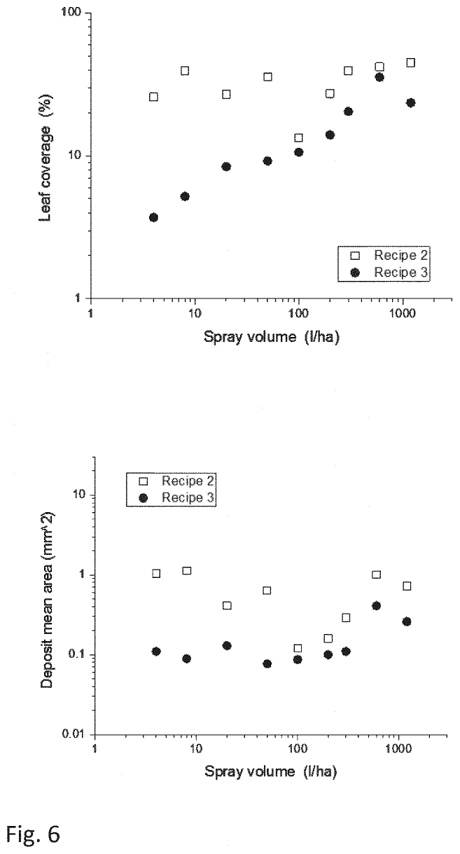

The same enhancement of coverage can be seen with the mean spray deposit area, recipe 2 (for the described sprayable liquid for low volume spray application) remarkably also produced spray deposits with significantly higher spreading between 50 and 4 l/ha. Higher spray volumes of 100 and 200 l/ha produced deposits with much lower areas as did the reference recipe at 4 to 300 l/ha. The results from table XII are plotted in FIG. 6.

Both of these results demonstrate the advantage of the described sprayable liquid at low volume spray application between 4 and 50 litres per hectare for application by an unmanned aerial vehicle as described here.

### Example 4: Low Spray Volumes

Formulations were prepared with the following recipes:

TABLE XII

| | Recipe 4 For |
|---|---|
| | the described |
| | sprayable liquid |
| | for low volume |
| Component (g/l) | spray application |
| Trifloxystrobin (a) | 120 |
| Tebuconazole (a) | 240 |
| Non-ionic dispersants (e1) | 25 |
| Anionic dispersants (e3) | 20 |
| Geropon ® DOS-PG (b) | 20 |
| Silwet ® 408 (c) | 35 |
| Synperonic ® PE L62 (i) | 35 |
| Xanthan (f) | 1.0 |
| Proxel ® GXL (h) | 1.8 |
| Kathon ® CG/ICP (h) | 0.8 |
| Atplus ® FA (d) | 40 |
| Glycerine (h) | 100 |
| SAG ® 1572 (g) | 5 |
| Na₂HPO₄/NaH₂PO₄ | 1.5/0.8 |
| (Buffer solution pH = 7) | |
| Water | To volume (~474) |

The method of preparation used was according to Method 1.

In an example recipe 4 for the described sprayable liquid for low volume spray application and the commercial product Nativo® 300 SC (Bayer AG, registration number L8942 South Africa, code 102000008381) which contains 100 g/l of trifloxystrobin and 200 g/l of tebuconazole were applied by spray application to paddy rice using a low spray volume of 60 l/ha and assessed for control of neck blast disease after two applications. The treated crops were then harvested and the yield measured.

TABLE XIV
Biological results for recipe 4 and Nativo ® SC.

| | Trifloxystrobin | | | |
|---|---|---|---|---|
| | and tebuconazole | % disease | % disease | Yield |
| Formulation | rate g/ha | control 21 daa | control 28 daa | dt/ha |
| Recipe 4 | 60 + 120 | 83 | 78 | 147 |
| Recipe 4 | 105 + 210 | 82 | 81 | 147 |
| Nativo ® | 60 + 120 | 60 | 67 | 139 |
| SC | | | | |
| Nativo ® | 105 + 210 | 70 | 64 | 142 |
| SC | | | | |

The results show that at the low spray volume of 60 l/ha recipe 4 or the described sprayable liquid for low volume spray application gave both significantly higher disease control and increased yield compared to the commercial reference Nativo® SC.

### Example 5: Insecticides

TABLE XV
Formulations were prepared with the following recipes:

| | Recipe 5 For | | |
|---|---|---|---|
| | the described | | |
| | sprayable liquid | | |
| | for low volume | Recipe 6 | Recipe 7 |
| Component (g/l) | spray application | reference | reference |
| Thiacloprid (a) | 200 | 200 | 200 |
| Non-ionic dispersants (e1) | 20 | 20 | 20 |
| Anionic dispersants (e3) | 8 | 8 | 8 |
| Geropon ® DOS-PG (b) | 20 | 15 | 0 |
| Silwet ® 408 (c) | 35 | 0 | 0 |
| Synperonic ® PE L62 (i) | 35 | 0 | 0 |
| Xanthan (f) | 2.0 | 2.0 | 2.0 |
| Proxel ® GXL (h) | 1.8 | 1.8 | 1.8 |
| Kathon ® CG/ICP (h) | 0.8 | 0.8 | 0.8 |
| Atplus ® FA (d) | 50 | 50 | 0 |
| Glycerine (h) | 100 | 100 | 100 |
| SAG ® 1572 (g) | 6 | 6 | 6 |
| Na₂HPO₄/NaH₂PO₄ (Buffer | 1.5/0.8 | 0 | 0 |
| solution pH = 7) | | | |
| Water | To volume | To volume | To volume |
| | (~601) | (~677) | (~742) |

The method of preparation used was according to Method 1.

Recipes 5, 6 and 7 along with a small amount of a fluorescent label were sprayed onto rice leaves at a spray volume of 10 l/ha and formulation rate of 1.0 l/ha and the coverage of the spray measured from the fluorescence under UV illumination using ImageJ image analysis software (Fiji package, www.fiji.com).

TABLE XVI
Leaf coverage results

| Formulation | % coverage on rice leaves |
|---|---|
| Recipe 5 | 31.5 |
| Recipe 6 | 5.7 |
| Recipe 7 | 5.6 |

The results show that recipe 5 for the described sprayable liquid for low volume spray application showed significantly higher coverage than the reference recipes 10 and 11.

### Example 6: Herbicide

TABLE XVII
Formulations were prepared with the following recipes:

| | Recipe 8 For | |
|---|---|---|
| | the described | |
| | sprayable liquid | |
| | for low volume | Recipe 9 |
| Component (g/l) | spray application | reference |
| Diflufenican (a) | 200 | 200 |
| Non-ionic dispersants (e1) | 20 | 20 |
| Anionic dispersants (e3) | 8 | 8 |
| Geropon ® DOS-PG (b) | 15 | 0 |
| Silwet ® 408 (c) | 30 | 0 |
| Synperonic ® PE L62 (i) | 30 | 0 |
| Xanthan (f) | 2.0 | 3.0 |
| Proxel ® GXL (h) | 1.8 | 1.8 |
| Kathon ® CG/ICP (h) | 0.8 | 0.8 |
| Atplus ® FA (d) | 50 | 0 |
| Glycerine (h) | 90 | 100 |
| SAG ® 1572 (g) | 6 | 6 |
| Na₂HPO₄/NaH₂PO₄ | 1.5/0.8 | 0 |
| (Buffer solution pH = 7) | | |
| Water | To volume | To volume |
| | (~624) | (~749) |

The method of preparation used was according to Method 1.

Recipes 8 and 9 along with a small amount of a fluorescent label were sprayed onto rice leaves at a spray volume of 10 l/ha and formulation rate of 0.5 l/ha and the coverage of the spray measured from the fluorescence under UV illumination using ImageJ image analysis software (Fiji package, www.fiji.com).

TABLE XVIII
Leaf coverage results

| Formulation | % coverage on rice leaves |
|---|---|
| Recipe 8 | 35.8 |
| Recipe 9 | 3.2 |

The results show that recipe 8 for the described sprayable liquid for low volume spray application showed significantly higher coverage than the reference recipe 13.

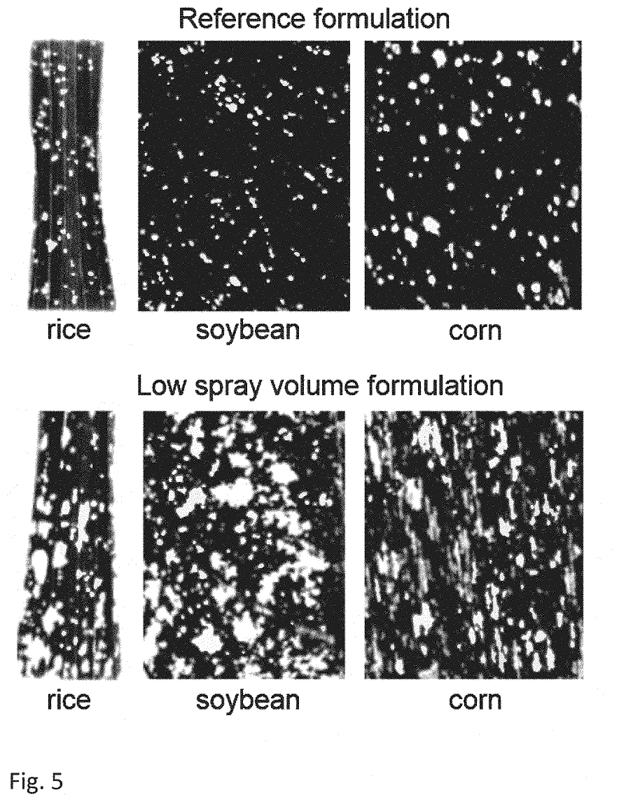

FIG. 5 shows images of spray deposits on rice, soybean and corn leaves. The top images show the results for a reference formulation (recipe 3) and the bottom images show the results for a sprayable liquid for low volume application as described here (recipe 2) after spray application by drone at a spray volume of 8 l/ha.

### Technical Supporting Notes:

The kinetic energy (KE) of spray droplets depends both on the droplet size (mass m) and droplet velocity (v) where KE=½mv2, spray application by UAV results in a marked increase in the kinetic energy of the spray droplets from the high downdraught from the rotors, high kinetic energy results in higher rebound of the spray from leaf surfaces. As the droplet's kinetic energy increases the dynamic surface tension needs to decrease to prevent an increase in the spray rebound. However, this is addressed by the described sprayable liquid for low volume application.

Dynamic wetters are small adjuvants/surfactants that can diffuse rapidly to the air-water interface reducing the surface tension and increasing the leaf adhesion which lessen the droplet recoil, as provided by the described sprayable liquid for low volume application.
Dynamic wetters, a formulation without dynamic wetters may have sufficient spray retention with a fine spray, but with a coarse low drift spray the spray drops will have much higher kinetic energy and consequently reduced spray retention.
   Wash-off by rain is potentially a route to high losses of active ingredients from the crop, and therefore rain-fast additives can be built into formulations to mitigate this, as provided by the described sprayable liquid for low volume application.
The choice of formulation is a complex combination of many factors. For particulate formulations, this is most readily achieved with advanced flowable formulations.
   Biodelivery is governed by the micro-structure of the spray deposits, especially the distribution of the active ingredient(s) and adjuvants. For particulate systems this is very complex and can involve the formation of ‘coffee ring structures’, and is addressed by the described sprayable liquid for low volume application.
The deposit micro-structure is dependent on both the formulation design and the spray volume, with higher biodelivery achieved with low spray volumes well below full leaf coverage for poorly soluble active ingredients.
Leaf coverage can also apply with low spray volumes, depending on the required biodelivery of each active ingredient. For enhanced penetration low coverage can give enhanced uptake; for flowables with adjuvants this can be from compact ‘coffee ring’ deposits.
   Spray volume. For high coverage the addition of high spreading adjuvants such as high spreading adjuvants/surfactants (e.g. organosilicones) can deliver good coverage at low spray volumes, as provided by the described sprayable liquid for low volume application. For a relatively low amount of ‘spreading surfactant’ enhanced spreading can be observed from spray volumes equal to or below 60 l/ha. As the spray volume is decreased the concentration of the adjuvant/surfactant increases with enhanced spreading continuing even to the low spray volumes used in aerial application of 8 l/ha and below.
   For wetting to occur it is necessary for the contact angle θ<90° since for θ<90° leaf surface ‘micro-structure’ enhances wetting while for θ>90° leaf surface ‘micro-structure’ enhances non-wetting, with the described sprayable liquid for low volume application leading to movement toward smaller contact angles.
   The target spray volume at which the adjuvant concentration becomes sufficient for enhancing spray retention and leaf wetting with application via a vehicle as discussed above should be equal to or less than 60 l/ha with adjustments where required, with the upper limit providing the onset of a good balance between the various competing requirements. This is achieved by the described sprayable liquid for low volume application.

All these effects described under supporting notes, relate to an incredibly complex juxtaposition of elements relating to how liquids can be sprayed on crops. It has been found that the described sprayable liquid for low volume spray applications provides surprising beneficial effects, provided by an optimum combination of these elements that can compete against one another. In the described sprayable liquid an optimum sprayable liquid with a combination of these elements is provided.

In some embodiments, a computer program or computer program element is provided that is characterized by being configured to execute the method steps of the method according to one of the preceding embodiments, on an appropriate system.

The computer program element might therefore be stored on a computer unit, which might also be part of an embodiment. This computing unit may be configured to perform or induce performing of the steps of the method described above. Moreover, it may be configured to operate the components of the above described apparatus and/or system. The computing unit can be configured to operate automatically and/or to execute the orders of a user. A computer program may be loaded into a working memory of a data processor. The data processor may thus be equipped to carry out the method according to one of the preceding embodiments.

This exemplary embodiment of the invention covers both, a computer program that right from the beginning uses the invention and computer program that by means of an update turns an existing program into a program that uses invention.

Further on, the computer program element might be able to provide all necessary steps to fulfill the procedure of an exemplary embodiment of the method as described above.

According to a further exemplary embodiment of the present invention, a computer readable medium, such as a CD-ROM, USB stick or the like, is presented wherein the computer readable medium has a computer program element stored on it which computer program element is described by the preceding section.

A computer program may be stored and/or distributed on a suitable medium, such as an optical storage medium or a solid state medium supplied together with or as part of other hardware, but may also be distributed in other forms, such as via the internet or other wired or wireless telecommunication systems.

However, the computer program may also be presented over a network like the World Wide Web and can be downloaded into the working memory of a data processor from such a network. According to a further exemplary embodiment of the present invention, a medium for making a computer program element available for downloading is provided, which computer program element is arranged to perform a method according to one of the previously described embodiments of the invention.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfill the functions of several items re-cited in the claims. The mere fact that certain measures are re-cited in mutually different dependent claims does not indicate that a combination of these measures cannot be used to advantage. Any reference signs in the claims should not be construed as limiting the scope.

1. An unmanned aerial vehicle for application of an active ingredient to agricultural crops, comprising:
a liquid reservoir is configured to hold a liquid comprising the active ingredient; and
at least one liquid applicator in fluid communication with the liquid reservoir;
wherein the unmanned aerial vehicle is configured to
receive, at the at least one liquid applicator, at least one input from a processor, wherein the at least one input is useable to activate the at least one unit applicator;
land within an environment to apply the liquid to at least one plant; and
activate the at least one liquid applicator at a location determined by the processor based on image analysis of at least one image of the environment acquired by a camera.

2. The unmanned aerial vehicle according to of claim 1, wherein the unmanned aerial vehicle comprises a camera, wherein the camera is configured to acquire the at least one image.

3. The unmanned aerial vehicle of claim 1, wherein the unmanned aerial vehicle comprises a processor, wherein the processor is configured to carry out the analysis of the at least one image to determine the location for activation of the at least one liquid applicator.

4. The unmanned aerial vehicle to claim 1, wherein analysis of the at least one image to determine the at least one location for activation of the at least one liquid applicator comprises a determination of at least one of the following: at least one type of weed, at least one type of disease, at least one type of pest, at least one type of insect, or at least one type of nutritional deficiency.

5. The unmanned aerial vehicle of claim 1, wherein analysis of the at least one image to determine the at least one location for activation of the at least one liquid applicator comprises a determination of a site for the unmanned aerial vehicle to land.

6. The unmanned aerial vehicle of claim 14, wherein the unmanned aerial vehicle is configured to land on at least one extendable leg that is attached to a body of the unmanned aerial vehicle.

7. The unmanned aerial vehicle of claim 6, wherein an end of the at least one extendable leg that is distal to an end of the at least one extendable that is attached to the body of the unmanned aerial vehicle comprises at least one stability structure.

8. The unmanned aerial vehicle of claim 1, wherein the at least one liquid applicator is moveable with respect to a body of the unmanned aerial vehicle, wherein a processor of the unmanned aerial vehicle is configured to move the at least liquid applicator.

9. The unmanned aerial vehicle of claim 8, wherein the at least one liquid application unit applicator is mounted on at least one extendable arm.

10. The unmanned aerial vehicle of claim 8, wherein when the unmanned aerial vehicle has landed within the environment the processor is configured to move the at least one liquid applicator to the location for activation of the at least one liquid applicator based on the image analysis of the at least one image of the environment.

11. The unmanned aerial vehicle of claim 1, wherein when the unmanned aerial vehicle comprises a camera, the camera is configured to move with respect to the body of the unmanned aerial vehicle, wherein a processor of the unmanned aerial vehicle is configured to move the camera.

12. The unmanned aerial vehicle of claim 1, wherein the unmanned aerial vehicle is configured to determine the location for activation of the at least one liquid application unit after the unmanned aerial vehicle has landed within the environment.

13. The unmanned aerial vehicle of claim 1, wherein the unmanned aerial the vehicle comprises location determining means.

14. A system for application of an active ingredient to agricultural crops, comprising:
at least one unmanned aerial vehicle comprising:
a liquid configured to hold a liquid comprising the active ingredient; and
at least one liquid applicator in fluid communication with the liquid reservoir;
at least one camera configured to acquire the at least one image of the environment; and
at least one processor;
wherein an unmanned aerial vehicle of the at least one unmanned aerial vehicle is configured to receive, via a processor of the at least one processor, data useable to activate the at least one liquid applicator of the unmanned aerial unit;
wherein the camera is configured to transmit the at least one image to the processing unit processor; and
wherein the processor is configured to analyze the at least one image to determine at least one location for activation of the at least one liquid applicator of the unmanned aerial vehicle that is in fluid communication with the liquid reservoir of the unmanned aerial vehicle.

15. A method for application of an active ingredient by an unmanned aerial vehicle to agricultural crops, comprising:
holding a liquid comprising the active ingredient in a liquid reservoir housed within or attached to a body of the unmanned aerial vehicle, wherein a liquid applicator is attached to the body of the unmanned aerial vehicle, and the liquid applicator is in fluid communication with the liquid reservoir;
receiving by the liquid applicator at least one input from a processor, wherein the at least one input is useable to activate the liquid applicator;
landing the unmanned aerial vehicle within an environment to apply the liquid to at least one plant; and
activating the liquid applicator at a location determined by the processor based on image analysis of at least one image of the environment acquired by a camera.
